(19) United States
(12) Patent Application Publication
(10) Pub. No.: US 2008/0217803 A1
(43) Pub. Date: Sep. 11, 2008

(54) Method of Molding a Hydrodynamic Pressure Producuing Part

(75) Inventors: Tatsuo Nakajima, Shizuoka (JP); Arito Matsui, Shizuoka (JP); Isao Komori, Mie (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NTN CORPORATION, Osaka-shi (JP)

(21) Appl. No.: 11/791,019

(22) PCT Filed: Dec. 12, 2005
(86) PCT No.: PCT/JP05/22804

§ 371 Date: May 2, 2008

(30) Foreign Application Priority Data
Dec. 21, 2004 (JP) 2004-369850
Jan. 31, 2005 (JP) 2005-024141
Feb. 7, 2005 (JP) 2005-030758

(51) Int. Cl. B29C 43/00; B29C 35/08

(52) U.S. Cl. 264/132; 264/496

(57) ABSTRACT

To enable molding of a hydrodynamic pressure producing part on the flat surface of a material by simple steps highly accurately and at low costs. A microdroplet 13 of an ultraviolet curable type ink from a nozzle head 11 by the ink jet method is caused to land or dropped on the upper end face 2b1 of the material 2b′. The nozzle head 11 and a light source 14 which irradiates a ultraviolet ray are disposed sequentially according to the direction of travel of the material 2b′, and are provided at positions opposing the material 2b′. While the material 2b′ is relatively slid, landing or dropping of the ink from the nozzle head 11 and curing of the ink by the ultraviolet ray irradiated from the light source 14 are gradually conducted according to in the direction of travel of the material 2b′ to form the hydrodynamic pressure producing part.

### BACKGROUND OF THE INVENTION

(1) Field of the Invention

The present invention relates to a method of molding a hydrodynamic pressure producing part.

(2) Description of the Related Art

A hydrodynamic bearing is a bearing which produces pressure by the hydrodynamic effect of a lubricating oil which occurs in a bearing gap, by the relative rotation of a bearing component positioned on the outer periphery of a shaft member, and supports the shaft member in a non-contact manner by this pressure. This hydrodynamic bearing has features such as high-speed rotation, high rotational accuracy and reduced noise. In recent years, utilizing its features, such a bearing has been expanding its use as those for spindle motors of information appliance, for example, magnetic disk apparatuses such as HDD and FDD, optical disk apparatuses such as CD-ROM, CD-R/RW and DVD-ROM/RAM, magneto-optic disk apparatuses such as MD and MO and the likes, bearings for polygon scanner motors of laser beam printer (LBP), bearings for small motors of electrical machinery and apparatuses, for example, collar wheel motors of projectors, axial fan motors and the like.

Among this type of hydrodynamic bearings, there is a known hydrodynamic pressure producing part for producing pressure by the hydrodynamic effect of a fluid in the bearing gap comprising, for example, spirally arranged hydrodynamic grooves formed on a thrust bearing face by transfer printing (for example, refer to Japanese Unexamined Patent Publication No. 2004-052850).

Moreover, in this type of hydrodynamic bearings, for example, a hydrodynamic pressure producing part (for example, hydrodynamic grooves arranged in a herringbone shape, a spiral shape, etc.) for producing the hydrodynamic effect is formed on the outer circumferential surface of the shaft member. Known methods of accurately forming this peculiar and complicated hydrodynamic pressure producing part include the methods (1)-(3) mentioned below.

(1) When the hydrodynamic pressure producing part is constituted of, for example, hydrodynamic grooves, the parts other than the hydrodynamic grooves are printed with a corrosion-resistant ink by a combination of electrochemical methods on the outer periphery of the shaft member to corrode unprinted parts by etching, forming hydrodynamic grooves.

(2) With the shaft member being brought into contact with the printing mold of a printing apparatus, the shaft member is caused to make a single full rotation to print the parts other than the hydrodynamic grooves on the outer periphery of the shaft member with a corrosion-resistant ink. Then, an etching process of unprinted parts is carried out to form hydrodynamic grooves.

(3) The printing mold is moved in response to the rotation of the shaft member with the printing mold being brought into contact with the outer circumferential surface of the shaft member, whereby the parts other than the hydrodynamic grooves are printed on the outer periphery of the shaft member with a corrosion-resistant ink, while the positions other than the parts that are brought into contact with the printing mold of the shaft member are irradiated with a light beam to cure the ink (for example, refer to Japanese Examined Patent Publication No. S62-49351).

### BRIEF SUMMARY OF THE INVENTION

In Unexamined Patent Publication No. 2004-052850, transfer printing for forming hydrodynamic pressure producing part (hydrodynamic grooves) is carried out in general according to the procedure shown below. Firstly, an ink is poured onto a printing plate member having recesses corresponding to the shape of hydrodynamic grooves, and the ink overflowing from the recesses is removed with a squeegee (printing plate preparation step). Secondly, a pad member is pushed against said printing plate member, and the ink filling the recesses is transferred onto the pad member (primary transfer step). Subsequently, the pad member to which the ink is transferred is pushed against a component forming a thrust bearing face, forming a predetermined shape of hydrodynamic grooves by printing (secondary transfer step). Finally, the ink remaining on the pad member is removed by a separately prepared ink removing member (ink removal step).

However, in molding of the hydrodynamic pressure producing part by transfer printing, a number of printing plate members (printing molds) that match the form and dimension of the hydrodynamic pressure producing part need to be maintained, and since printing is carried out with the printing plate members being in contact with pad member, in mass production, there is a concern of reduced printing precision due to the deformation, deterioration or the like of the pad member. In the printing plate preparation step, the printing plate member needs to be provided with an extra amount of the ink and the extra ink needs to be removed with a squeegee. In addition, because the ink remaining on the pad member is removed after the transfer printing, a large amount of ink that does not directly relate to the hydrodynamic pressure producing part is required. Moreover, since printing is carried out through many molds (steps), molding steps is complicated, making cost reduction difficult. In recent years, with lowering prices of information appliances, demand for reduced costs of this type of hydrodynamic bearing apparatuses are growing. To meet this request, it is strongly desired that molding steps of hydrodynamic pressure producing parts are simplified and hydrodynamic bearing apparatuses can be produced at low costs.

Moreover, among the methods described in Examined Patent Publication No. S62-49351, the method (1) is difficult to be rationalized because of complicated steps. By the method (2), while the shaft member completes a full revolution overlapping of an insufficiently cured ink occurs in the joint of printing, and therefore the shape of the grooves is likely to collapse, leading to the possible necessity of correcting the shape after the printing.

In contrast, in the method (3), since the printing mold moves in contact with the outer circumferential surface of the shaft member, abrasion is likely to be caused in the contacting portion. Thus in mass production, there is a concern of reduced printing precision due to the abrasion, deformation or the like of the printing mold. In addition, since a corrosion-resistant ink provided by an ink supply apparatus reaches the outer circumferential surface of the shaft member via the printing mold and further pressured by a squeegee so that it is fixated onto the outer circumferential surface of the shaft member, an extra amount of a corrosion-resistant ink that is not involved in the shape of the grooves is necessary. This uneconomically increases the amount of a costly corrosion-resistant ink used.

Moreover, the corrosion of unprinted parts by etching and removal of the corrosion-resistant ink are indispensable after printing. This makes molding steps complicated and numerous, contributing to raised costs.

Similarly, in the method of forming hydrodynamic grooves shown in Examined Patent Publication No. S62-49351, a printing mold move in contact with the outer circumferential surface of the shaft member, and abrasion is therefore likely to be caused in the contacting portion. Hence, there is a concern of reduced printing precision due to the abrasion, deformation or the like of the printing mold in mass production. Moreover, a corrosion-resistant ink provided by an ink supply apparatus reaches the outer circumferential surface of the shaft member via the printing mold and further pressured by a squeegee so that it is fixated onto the outer circumferential surface of the shaft member. Accordingly, an extra amount of a corrosion-resistant ink that is not involved in groove formation is necessary. This uneconomically increases the amount of a costly corrosion-resistant ink used. In addition, since printing molds corresponding to hydrodynamic grooves and material or shape are required in printing, addressing recent diverse requirements increases investment.

By the way, the performance of information appliances is remarkably enhanced these days. Although higher performance is required for hydrodynamic bearing apparatuses, information appliances are also buffeted by a great trend of prices to go lower. Therefore, there is a growing demand for cost reduction of hydrodynamic bearing apparatuses. However, known methods have the above-mentioned problems, and it is thus difficult for them to sufficiently meet this type of requirements.

A first object of the present invention is to form a hydrodynamic pressure producing part in simple steps highly accurately and at low costs.

A second object of the present invention is to simplify molding steps to form a hydrodynamic pressure producing part at low cost and highly accurately.

A third object of the present invention is to provide a method which enables the formation of a high-precision hydrodynamic pressure producing part at even lower costs.

To achieve said first object, the present invention provides a method of molding a hydrodynamic pressure producing part, the method comprising forming a hydrodynamic pressure producing part from an aggregate of a minute amount of the ink by undergoing a printing step in which a minute amount of an ink is provided at a plurality of portions on a flat surface of a material in a non-contact manner and a curing step in which the provided ink is cured.

In the present invention, the term “hydrodynamic pressure producing part” means a part which produces pressure by the hydrodynamic effect of a fluid in a bearing gap. For example, a part which comprises a plurality of grooves (axial grooves, slanted groove, or these grooves arranged in a spiral shape or a herringbone shape, radial grooves, etc.) and raised demarcation portions which are located between the grooves and forms demarcation of these, or a plurality of arcuate faces which contracts the bearing gap in one or both circumferential directions in a wedge shape and the like are included. The materials of the components for forming the hydrodynamic pressure producing part are not critical, and are suitably selected and used depending on bearing characteristics for which metallic materials (steel materials such as stainless steel, soft metals such as brass, sintered metals, etc.) and resin compositions are required. Moreover, the forms of material may be any of various forms such as a plate, sleeve, bottomed cylindrical and the like as long as they have flat surfaces.

According to the above molding method, printing can be carried out in the state that nozzles or the like ink feed section and a material are not in contact. Therefore, while high-precision printing is enabled, lowered printing precision in the contacting portion, which is a problem in a known method, can be avoided. Moreover, since an extra amount of the ink which has been provided onto a printing mold needs not be removed by a squeegee, the ink is used only in required portions. Therefore, only the amount of the ink that is involved in the formation of the hydrodynamic pressure producing part is necessary, enabling to reduce the amount of the ink used. Furthermore, a number of printing molds corresponding to the shape of the hydrodynamic pressure producing part which has been required are unnecessary. This eliminates the necessity of a plurality of steps, enabling the simplification of the structure of the molding apparatus. Typical examples of apparatuses which provide a minute amount of the ink from the nozzle include the ink jet method.

By the method of molding a hydrodynamic pressure producing part by the ink jet method, a pattern having a certain shape and thickness can be printed with aggregates of microdroplets of an ink caused to land or drop on a flat surface of a material. Moreover, high-precision pattern molding is enabled by programming such a pattern in advance and controlling the position and ink supply and stop of the nozzle according to the program. Accordingly, the cure ink itself can form a high-precision hydrodynamic pressure producing part.

In this case, the material is relatively slid after a printing step in which a minute amount of the ink is provided on the flat surface of the material in a non-contact manner and before a curing step in which the provided ink is cured, the supply and curing of the ink are successively proceeded so that a hydrodynamic pressure producing part can be formed with a simple apparatus and steps in a short period of time. Moreover, the material which has undergone the printing step and curing step may be again fed to the printing step to carry out printing and to the curing step to carry out curing. Thus, even when the material is fed again to the printing step, since the ink which has undergone the curing step once is completely cured, lowered printing precision due to overlapping of insufficiently cured ink can be avoided.

The printing in the above printing step, for example, can be carried out by using a nozzle head comprising nozzles discharging a minute amount of the ink arranged in a plurality of rows. In this case, the arrangement direction of the nozzles arranged in the nozzle head and the relative sliding direction of the material are desirably in a slanted state. When the arrangement direction of the nozzles is perpendicular to the relative sliding direction of the material, the interval of the ink which is provided from a nozzle during one cycle and lands on the material naturally becomes equal to the arrangement interval of the nozzles. In contrast, if the arrangement direction of the nozzles and the relative sliding direction of the material are slanted, the interval of the ink which is provided from a nozzle and lands on the material becomes less than the arrangement interval of the nozzle. Therefore, when printing is carried out using the nozzle head comprising the nozzles in the latter arrangement, the landing interval of the ink can be reduced, enabling to carry out printing more accurately.

It should be noted that the transport of the material from the printing step to the curing step can be carried out by the above relative sliding or by relatively rotating the material around its axis. In this case, the printing step and curing step are provided in different circumferential positions, whereby the printing and ink curing of the hydrodynamic pressure producing part can be simultaneously conducted of the material in the circumferential direction.

An ink used in the present invention can be cured by the irradiation of an electromagnetic wave such as electron beam and light beam, but considering costs, work circumstances, etc., it is desirable that a light curable ink is used and the ink is cured by the irradiation of a light beam. Usable light curable inks include ultraviolet curable type and infrared curable type inks, as well as visible light curable type inks. Ultraviolet curable type inks which can be cured at low cost and in a short period of time are especially desirable.

To achieve said second object, the present invention provides a method of molding a hydrodynamic pressure producing part, the method comprising a step in which a minute amount of the ink is provided on the surface of the material and a hydrodynamic pressure producing part is printed with aggregates of this minute amount of the ink and a step in which the ink is cured, the surface of the material being cleaned by means selected from acid cleaning, UV cleaning and ozone cleaning prior to the molding step of the hydrodynamic pressure producing part. A minute amount of the ink is provided in such a mode of discharging from an ink feed section, for example, a nozzle, and, for example, causing this to land or drop onto the surface of the material, so that printing can be carried out in such a state that the ink feed section (nozzle) and the material are not in contact. Therefore, while high-precision printing is enabled, lowered printing precision due to abrasion in the contacting portion, which has been a problem in a known method, can be avoided. Moreover, since a squeegee is unnecessary and the ink is provided only at required portions, the amount of the ink required can be only that involved in the formation of the hydrodynamic pressure producing part, enabling to reduce such material cost. Furthermore, since the printing mold and a retaining member for retaining for the printing mold (for example, net-like screen for printing, etc.) are unnecessary and a mechanism for moving the printing mold in response to the rotation of the material is also unnecessary, the structure of the molding apparatus can be simplified to achieve even further cost reduction. Typical examples of the methods which provide the ink from a nozzle include a feed method using ink jet.

In the ink jet method, for example, the printing pattern is programmed in advance and pattern printing is carried out by controlling the position and ink supply and stop of the nozzle according to the program. At this time, the molding precision of the printing pattern is greatly affected by the surface condition of the material to which the ink is to be fixated. That is, a material to whose surface the ink is fixated for forming the hydrodynamic pressure producing part is, for example, a shaft member, a bearing sleeve or the like in hydrodynamic bearings. The component parts of these hydrodynamic bearings, for example, are formed by cutting a metal or like means. Therefore, impurities such as cutting powders, machine oil, oils and fats are deposited on the outer circumferential surface of the shaft member after cutting. If the material is used in this state, the shape (for example, contact angle with the surface of the material) of a minute amount of the ink which has landed on a region in the surface of the material where the surface condition is not good (impurities are deposited) after it lands there may be different from that of the ink which has landed on other regions where the surface condition is good. Accordingly, a variation is caused in the shape of a minute amount of the ink after it has landed there (for example, contact angle with the surface), which may lead to unstable shapes of the hydrodynamic pressure producing part formed of the aggregates of these minute amount of the inks.

By the ink jet method, since the nozzle position is controlled assuming the shape of a minute amount of the ink after it has landed there (contact angle). If the shape of a minute amount of the ink after it lands there is not constant, even by controlling the nozzle position and highly accurately, the printing pattern (hydrodynamic pressure producing part) formed of the aggregates of a minute amount of the ink may be not be formed with high shape precision, depending on the position on the surface of the material on which it lands. A method of cleaning the surface the material with an organic solvent such as acetone is also possible, but these organic solvents have poor cleaning abilities, and therefore improving the surface condition of the material to a required level is difficult.

Hence, in the present invention, the surface of the material is cleaned by means selected from acid cleaning, UV cleaning and ozone cleaning prior to the step of forming the hydrodynamic pressure producing part. According to this, for example, impurities deposited on the surface of the material during the molding step of the material body are removed, and the surface of the material becomes uniform and is given a good surface condition. Therefore, in the printing step following this, the shape of a minute amount of the ink provided on the surface of the material, for example, a contact angle with the surface of the material can be constant, and the moldability of the printing pattern can be improved. Moreover, a variation in the surface condition of each material is suppressed to a low level so that the reproducibility of the printing pattern can be improved.

Usable cleaning means of the surface of the material include acid cleaning, UV cleaning, ozone cleaning and the like. For example, when the surface of the material is made of a metal, an acid cleaning with excellent solubility of the metal is preferably used. According to this, impurities deposited on the surface of the material can be removed, while an oxide film formed on the metal of the material surface can be removed, making the surface condition of the material more uniform and excellent.

For example, high-strength materials such as stainless steel are used as a shaft member used for a hydrodynamic bearing. In this case, hydrochloric acid, among acids, which has especially good solubility with stainless steel, is preferably used.

Moreover, the cleaning effect on the surface of the material can be also increased by carrying out acid cleaning of the surface of the material under the effect of ultrasound waves. Alternatively, the cleaning effect can be also increased by increasing a temperature under cleaning circumstances (for example, about 50° C.).

To achieve said third object, the present invention provides a method of forming a hydrodynamic pressure producing part for producing the hydrodynamic effect in a bearing gap on the surface of the material which constitutes a shaft portion made of a metal, the method comprising providing a minute amount of the ink in the state that a plurality of materials are connected in the axial direction, and forming a hydrodynamic pressure producing part from an aggregate of the minute amount of the ink on each material.

In the present invention, the hydrodynamic pressure producing part is formed on each material in the state that a plurality of materials are connected. Therefore, a hydrodynamic pressure producing part can be formed simultaneously to a plurality of materials in one printing step. Accordingly, for example, the number of preparation steps or the like can be reduced to shorten the cycle time, whereby the production costs of the hydrodynamic pressure producing part can be reduced.

In forming the hydrodynamic pressure producing part, specific possible methods of providing a minute amount of the ink include, for example, the so-called ink jet method by which the ink is caused to land or drop on the surface of the material from a pore nozzle, as well as the method which induces the ink utilizing electrophoresis, a nozzleless type ink jet method (nozzleless ink jet method) which squirts the ink droplets not from a nozzle but from the fluid level of the ink, the method of discharging the ink via a micropipette not in droplets but successively, or the method of shortening the distance to a fixation surface and causing the ink to land on the fixation surface upon discharging the ink, among others. It should be noted that these are collectively referred to as “ink jet methods and the like” in the following descriptions.

In the method of forming the hydrodynamic pressure producing part by the ink jet methods and the like, a pattern having a certain shape and thickness are programmed in advance and the position of the feed section (for example, nozzle) of the ink according to the program and of the supply and stop of the ink are controlled, whereby an optional and high-precision shape pattern can be printed. Moreover, each part of the shape pattern can be formed to have an optional thickness by controlling the output rate of the ink precisely. Therefore, the cure ink itself can ensure the required shape of the hydrodynamic pressure producing part.

Moreover, since printing by the ink jet methods and the like can be carried out in the state that the material and the nozzle are not in contact, reduced precision due to abrasion in the contacting portion, which has been a problem in a known method, can be avoided. Moreover, since an extra amount of the ink which has been provided onto a printing mold needs not be removed by a squeegee and the ink is used only in required portions, only the amount of the ink that is involved in the formation of the hydrodynamic pressure producing part is necessary, whereby the amount of the ink used can be reduced. Furthermore, the printing mold is unnecessary and a mechanism for moving the printing mold in response to the rotation of the shaft member is also unnecessary. Therefore, the molding apparatus can be simplified. The production costs can be reduced of the hydrodynamic bearing apparatus by employing such a printing method as the ink jet methods or the like,

In connecting a plurality of materials in the axial direction, to form the hydrodynamic pressure producing part highly accurately without a variation among each material, the coaxiality when the materials are connected is very important. Thus in the present invention, a through hole in the axial direction is provided on the material, and the coaxiality is ensured by inserting a fixture into said through hole. According to this, the coaxiality can be maintained only by using a plain fixture, and therefore a high-precision hydrodynamic pressure producing part can be formed for all the connected materials uniformly and at low costs.

It should be noted that each material may use the above-mentioned fixture, or each of the material may be connected by providing a projection at its one end and a recess at the other end and fitting a projection provided on one of the adjacent materials and a recess provided on the other material.

By the way, in known methods, printing is carried out in the state that the material (shaft member) and the printing mold are in contact. At this time, if a plurality of materials is connected in the axial direction, the coaxiality between the connected materials is lowered since connected materials warp due to the pressure applied to the contacting portion, whereby it may be difficult to ensure a desired precision of the hydrodynamic pressure producing part. In contrast, the use of the ink jet methods or the like as in the present invention allows printing to be carried out in the state that the material and the nozzle are not in contact. Therefore, the above event can be avoided so that a high-precision hydrodynamic pressure producing part can be formed on each of the plurality of materials.

The ink for forming the hydrodynamic pressure producing part used in the present invention can be cured by the irradiation of an electron beam, light beam or the like. Considering the economical aspect, work circumstances, etc. in the curing step, it is desirable that a light curable ink is used and the ink is cured by the irradiation of a light beam. As a light curable ink, ultraviolet curable type and infrared curable type inks, as well as visible light curable type inks, can be used. Ultraviolet curable type inks which can be cured at low costs and in a short period of time are especially desirable.

As mentioned above, according to the present invention, a hydrodynamic pressure producing part can be formed with high precision and at low costs using a simple apparatus.

Moreover, according to the present invention, the molding steps can be simplified and a hydrodynamic pressure producing part can be formed at low cost and highly accurately.

Moreover, according to the present invention, a high-precision hydrodynamic pressure producing part can be formed at lower costs.

### BRIEF DESCRIPTION OF SEVERAL VIEWS OF THE DRAWING

FIG. 1 is a side elevational view showing the summary of a printing apparatus by the ink jet method according to a first embodiment of the present invention.

FIG. 2A is a figure in which a nozzle head is disposed to be perpendicular to the direction of travel of a material. FIG. 2B is a figure in which the nozzle head is slantingly disposed at a predetermined angle off the direction of travel of the material.

FIG. 3 is a plan view of the upper end face of a flange portion.

FIG. 4A is an expanded sectional view in which a demarcation portion B is formed directly on the material end face. FIG. 4B is an expanded sectional view in case where an ink layer is formed on the end face of the material and the demarcation portion B is formed on the surface of said ink layer.

FIG. 5 is a side elevational view showing another constitution of the printing apparatus by the ink jet method.

FIG. 6 is across-sectional view of a spindle motor for information appliances integrating a hydrodynamic bearing apparatus.

FIG. 7 is a cross-sectional view showing a constitutional example of the hydrodynamic bearing apparatus.

FIG. 8 is a cross-sectional view showing another constitutional example of the hydrodynamic bearing apparatus.

FIG. 9 is a cross-sectional view showing another constitutional example of the hydrodynamic bearing apparatus.

FIG. 10A is a plan view showing another form of the upper end face of a flange portion. FIG. 10B is an X-X expanded sectional view of the demarcation portion B when it is integrated into the hydrodynamic bearing apparatus.

FIG. 11 is a figure showing an example of the molding apparatus of the hydrodynamic pressure producing part according to a second embodiment of the present invention.

FIG. 12 is a figure showing another form of a method of molding the hydrodynamic pressure producing part.

FIG. 13 is a cross-sectional view of the hydrodynamic bearing apparatus.

FIG. 14 is a cross-sectional view showing another constitutional example of the hydrodynamic bearing apparatus.

FIG. 15 is a cross-sectional view showing another constitutional example of the hydrodynamic bearing apparatus.

FIG. 16 is a cross-sectional view showing another constitutional example of the hydrodynamic bearing apparatus.

FIG. 17 is a cross-sectional view showing an example of a spindle motor integrating a hydrodynamic bearing apparatus.

FIG. 18 is a figure showing the results of the cleaning tests of the surface of the material.

FIG. 19 is a schematic drawing showing an example of a printing apparatus by the ink jet method according to a third embodiment of the present invention.

FIG. 20 is a schematic drawing showing another form of a printing apparatus by the ink jet method.

FIG. 21 is across-sectional view showing a constitutional example of the hydrodynamic bearing apparatus having the constitution of the present invention.

FIG. 22 is a cross-sectional view showing another constitutional example of the hydrodynamic bearing apparatus.

FIG. 23 is a cross-sectional view showing another constitutional example of the hydrodynamic bearing apparatus.

FIG. 24 is a schematic drawing showing an example of a motor integrating a hydrodynamic bearing apparatus.

### DETAILED DESCRIPTION OF THE INVENTION

The first embodiment of the present invention will be depicted below with reference to FIGS. 1-10.

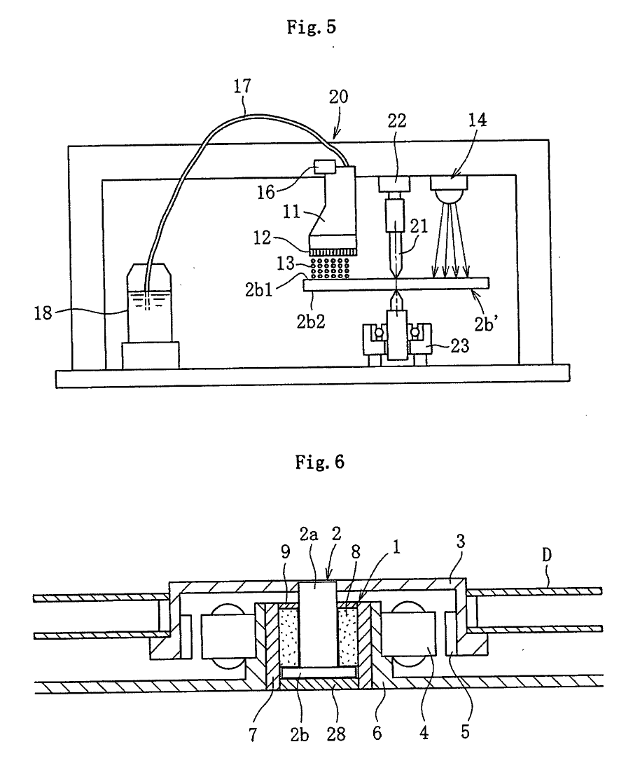

FIG. 1 shows the summary of the molding step of the hydrodynamic pressure producing part using an ink jet printing apparatus as an example of a method of molding a hydrodynamic pressure producing part according to the present invention. The example shown in this FIG. shows the summary a molding apparatus and steps which forms hydrodynamic pressure producing part on the upper end face 2b1 of a material 2b′ which constitutes a flange portion 2b in a shaft member 2 shown in FIG. 5.

In this molding apparatus, the material 2b′ is transported by, for example, a transport device 15 such as a conveyor. This transport device 15 transports the material 2b′ by relatively sliding it in a straight line from the printing step to the curing step. The material 2b′ is, for example, in the shape of a plate made of a metallic material such as stainless steel. Opposing the flat surface of the material 2b′, for example, the upper end face 2b1, A pair or pairs of nozzle head 11 and light source 14 are disposed. In this embodiment, by the nozzle head 11 and the region opposing it (the transport device 15), the ink is provided to a plurality of portions of the upper end face 2b1 of the material 2b′ (printing step), and by the light source 14 and the region opposing it (transport device 15), the ink provided at the plurality of positions is cured (a curing step). Therefore, the nozzle head 11 and light source 14 are sequentially disposed along the sliding direction of the material 2b′.

At the tip of the nozzle head 11, nozzles 12 which eject the ink are provided in a plurality of horizontal and vertical rows. The ink accumulated in an ink tank 18 is fed to the nozzle head 11 via an ink supply pipe 17, and is further intermittently ejected as a microdroplet 13 from each nozzle 12 of the nozzle head 11 driven by a nozzle head drive portion 16. The discharge system of the ink from the nozzle 12 is not especially limited, and various discharge system such as piezo system, thermal ink jet system and air jet system may be selected. A constitution corresponding to the discharge system is employed as the nozzle head drive portion 16. Moreover, printing method may be the continuous system or on-demand system.

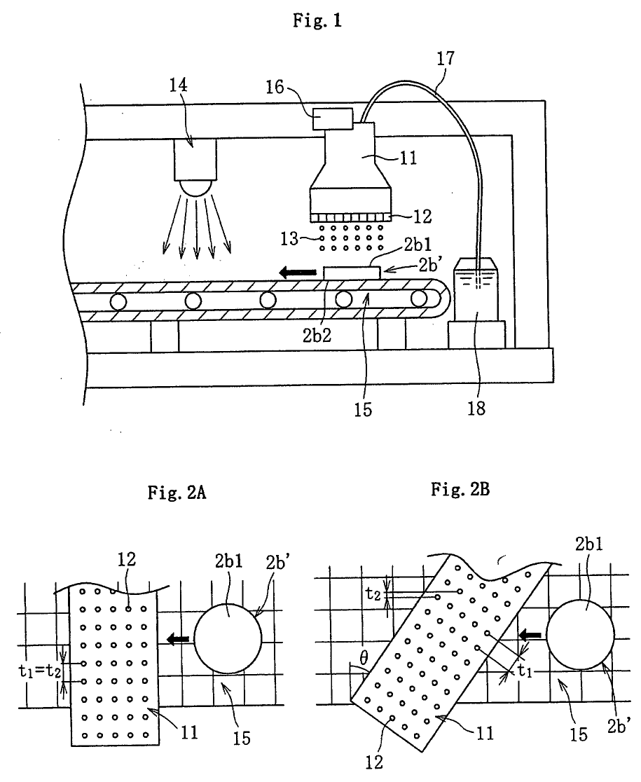

The nozzle head 11 is disposed to intersect the relative sliding direction of the material 2b′ (transport device 15). At this time, the nozzle head 11 can be disposed to be perpendicular to the relative sliding direction of the material 2b′ the arrangement direction (in the FIG. 2A, vertical direction of the drawing) of each nozzle 12, as shown in FIG. 2A, while it may be disposed with an inclination by a predetermined angle θ between the relative sliding direction of the material 2b′ and the arrangement direction of each nozzle 12, as shown in FIG. 2B. In case of the form shown in FIG. 2A, a landing interval t2 of the microdroplet 13 in one discharge becomes equal to an arrangement interval t1 of the nozzle 12. In contrast, in case of the form shown in FIG. 2B, a landing interval t2 of the microdroplet 13 becomes narrower than an arrangement interval t1 of the nozzle 12, advantageously allowing more accurate printing.

In this embodiment, an ultraviolet irradiation lamp is used as the light source 14. Accordingly, an ink used in ink jet printing is a commercially available ultraviolet curable type ink. The ultraviolet curable ink fixates by ultraviolet irradiation to cause a polymerization reaction. A liquid high-molecular material or a liquid high-molecular material containing a solvent may be used as long as it can be discharged from the nozzle 12. Any organic solvent may be used as the solvent as long as it has a characteristic of dissolving an ultraviolet curable ink.

Examples of ultraviolet curable resins constituting the base resin of the ultraviolet curable ink include radical polymerizable monomers, radical polymerizable oligomers and cationic polymerizable monomers, as well as imide acrylate or cyclic polyene compounds and en-thiol compounds typically including polythiol compounds. Among these, radical polymerizable monomers and radical polymerizable oligomers, cationic polymerizable monomers can be favorably used. Examples of usable radical polymerizable monomers include monofunctional, bifunctional or multifunctional acrylate monomers and methacrylate monomers. Examples of usable radical polymerizable monomers include urethane acrylate, epoxy acrylate, polyester acrylate, or unsaturated polyester, among others. Moreover, examples of cationic polymerizable monomers include bisphenol A epoxy resins, phenolic novolac epoxy resins, alicyclic epoxy resins, as well as 3-ethyl-3-hydroxymethyloxetane, 1,4-bis{[(3-ethyl-3-oxethanyl)methoxy]methyl}benzene, 3-ethyl-3-(phenoxymethyl)oxetane, di[1-ethyl(3-oxethanyl)]methylether, 3-ethyl-3-(2-ethylhexyloxymethyl)oxetane, 3-ethyl-3-{[3-(triethoxysilyl)propoxymethyl}oxetane and like oxetane resins. These ultraviolet curable resins may be used singly or in combination of two or more kinds as a base resin.

Among these base resins, a radical photopolymerization initiator for causing polymerization reaction by ultraviolet irradiation, cationic photopolymerization initiator and like photopolymerization initiators can be used. Examples of usable radical photopolymerization initiators are hydrogen abstraction type photopolymerization initiators typically including benzophenone, methyl ortho-benzoylbenzoate, 4-benzoyl-4′-methyldiphenyl sulfide, ammonium salts of benzophenone, isopropyl thioxanthone, diethyl thioxanthone and ammonium salts of thioxanthone, or intramolecular cleavage-type photopolymerization initiators typically including benzoin derivatives, benzyl dimethyl ketal, α-hydroxyalkylphenone, α-aminoalkylphenone, acylphosphine oxide, monoacylphosphine oxide, bisacylphosphine oxide, acrylphenyl glyoxylate, diethoxy actophenone, and titanocene compounds. Moreover, examples of usable cationic photopolymerization initiators include triphenylsulfonium hexafluoroantimonate, polyaryl sulfonium salts including, for example, triphenylsulfoniumhexafluorophosphate, SP-170, SP-150 (both manufactured by ASAHI DENKA KOGYO K.K.), FC-508, FC-512 (both manufactured by 3M Company), UVE-1014 (manufactured by General Electric company), mixtures of triallyl sulfonium hexafluorophosphate salts including, for example, Uvacure 1590, Uvacure 1591 (both manufactured by Daicel UCB), metallocene compounds such as Irg-261 (manufactured by Ciba-Geigy Corp.), diphenyl iodonium hexafluoroantimonate and P-nonyl phenyl phenyl iodonium hexafluoroantimonate, 4,4′-diethoxy phenyl iodonium hexafluoroantimonate and like polyaryl iodonium salts. These photopolymerization initiators may be used singly or in combination of two or more kinds.

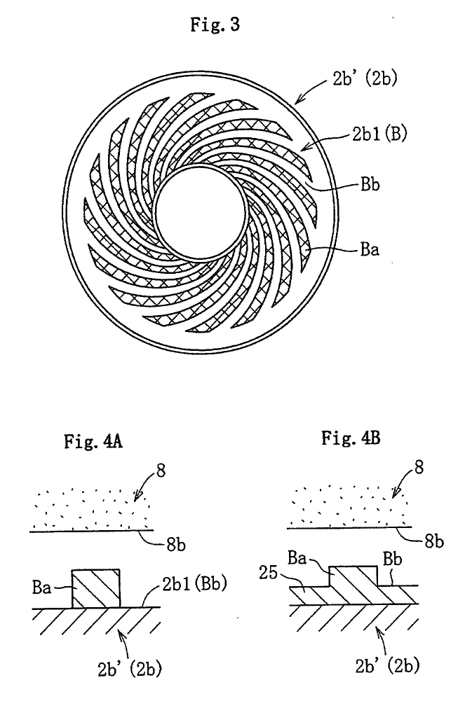

In the above constitution, while the transport device 15 is driven and the material is slid in the direction of the arrow 2b′ shown in FIG. 1, the microdroplet 13 of the ink is ejected from the nozzle 12. Accordingly, the demarcation portion B forming a projection with aggregates of the microdroplet 13 of the ink is formed at a plurality of portions of the upper end face 2b1 of the material 2b′. In contrast, a region not coated by the ink other than the demarcation portion B becomes a hydrodynamic groove Bb. Using these demarcation portions Ba and hydrodynamic grooves Bb, for example, the pattern of spirally arranged hydrodynamic grooves as shown in FIG. 3 is printed as a hydrodynamic pressure producing part. At this time, at each nozzle 12, since the supply and stop of the ink are suitably switched with a predetermined timing in advance, highly accurate printing is enabled. After printing is completed, the material 2b′ reaches a region opposing the light source 14, the ink which has received the ultraviolet irradiation causes a polymerization reaction to be cured. At this time, since the nozzle head 11 and light source 14 are disposed away from each other in the transport direction, the ultraviolet ray irradiated from the light source 14 is not irradiated upon the nozzle 12, clogging or other problems of the nozzle 12 due to the ultraviolet irradiation can be therefore prevented.

After all the ink has been cured in such a manner, the material 2b′ is further slid so that it is withdrawn from the transport device 15. At this time, if a plurality of materials 2b′ are continuously fed to the transport device 15, cured materials 2b′ with a hydrodynamic groove pattern printed thereon can be produced in quantity. When a hydrodynamic groove pattern is formed on the lower end face 2b2 of the material 2b′, a molding apparatus for the lower end face 2b2 having the nozzle head 11 and light source 14 downstream of the molding apparatus shown in FIG. 1 may be separately set up, and materials 2b′ may be fed sequentially to both molding apparatuses. Otherwise, the molding apparatus shown in FIG. 1 may be mutually used for printing and curing of a hydrodynamic groove pattern on both end faces 2b1, 2b2. In this case, after the hydrodynamic groove pattern on either of the end faces is printed and cured, the materials 2b′ are inverted and fed to the molding apparatus shown in FIG. 1 again, and printing and curing of the hydrodynamic groove pattern to the other end face are carried out.

In the above description, the case where printing of the hydrodynamic groove pattern is carried out by fixing the nozzle head 11 and sliding the materials 2b′ is shown as an example. On the other hand, in the state that the materials 2b′ are standing still, the nozzle head 11 may be reciprocated by sliding to carry out printing. Moreover, as mentioned above, printing and curing of the hydrodynamic groove pattern on the end faces of the materials 2b′ can be carried out at one time, or dividedly in a plurality of steps. In this case, since the ink which has undergone the curing step once is completely cured, reduced printing precision due to overlapping of insufficiently cured ink can be avoided if printing is carried out again thereafter.

The nozzle head 11 precisely discharges the microdroplet 13 of the ink in accordance with a preliminarily programmed shape. Therefore, a hydrodynamic groove pattern as a highly accurately hydrodynamic pressure producing part can be printed. In addition, as shown in FIG. 4A, since the cure ink itself can ensure a required depth (a few μm to a few ten μm) of the hydrodynamic grooves, it can be used as the shaft member 2 with hydrodynamic grooves as it is without undergoing following etching and like steps.

Moreover, since printing by the ink jet system does not have a part contacting the pad member as in known transfer printing and is carried out in a non-contact state, reduced printing precision due to deterioration or other problems of the contacting part can be avoided, the hydrodynamic groove precision can be ensured stably in mass production. Moreover, since it is not necessary to provide the ink in an extra amount, remove it by a squeegee and remove the ink remaining on the pad member are not necessary, the ink used is required only in an amount involved in the formation of the hydrodynamic groove pattern. Therefore, the amount of the ink used can be reduced to reduce costs. In addition, a hydrodynamic pressure producing part forming a predetermined shape only in one step can be formed, and thus the hydrodynamic pressure producing part needs not be formed by undergoing a plurality of steps. This also makes a printing mold unnecessary, the cycle time can be shortened and molding costs can be reduced. Further, the apparatus can be a very small one, enabling great price reduction of the printing apparatus.

In FIG. 4A, although the case where the hydrodynamic groove Bb is formed from a uncoated part of the ink is shown as an example, as shown in FIG. 4B, the hydrodynamic groove Bb can be formed from the part coated with the ink (ink layer) 25. In case of the latter, the entire end faces of the materials 2b′ are coated with the ink, the raised demarcation portion Ba is further integrally formed thereon. In this constitution, compared to the case shown in FIG. 4A, the amount of the ink used is increased, but the adhesion area of the ink with the material 2b′ is also increase, reduced fatigue life due to peeling of the ink or like problems can be suppressed.

Examples of usable fixating system of the ink include not only the ink jet air jet system stated above, but also a method of discharging droplets utilizing electrophoresis, that is, a nozzleless type ink discharge system which squirts ink droplets not from a nozzle but from an ink fluid level, a system which discharges the ink via a micropipette not in droplets but successively onto the surface of the material, and a system which shortens the distance between the surface of the material and brings into contact with on a fixation surface upon discharging the ink. A constitution corresponding to each discharge system can be employed at the nozzle head drive portion 16.

FIG. 5 shows another constitutional example of the molding apparatus of the hydrodynamic groove pattern. In this constitutional example, the material 2b′ is relatively rotated to form the hydrodynamic groove pattern on one of the end faces or on both end faces.

In the constitution of FIG. 5, the material 2b′ is supported by shaft-like retainers 21 pressed from its upper and lower end faces. The retainers 21 are rotatably supported by a rolling bearing 23, and a rotationally drive 22 comprising a motor or the like is connected to one of the retainers 21. By starting the rotationally drive 22, the material 2b′ which has received rotational drive force via the retainer 21 is rotationally driven. The nozzle head 11 and light source 14 are disposed opposing the upper end face 2b1 of the material 2b′ and with its circumferential direction position different, preferably in an opposition position across the retainer 21 as shown in the FIG. It should be noted that the constitution and identical constitutional components shown in FIG. 1 are denoted by identical numerals, and repeated explanation will be dispensed with including their functions.

In the above constitution, while the material 2b′ is rotated, the ink is discharged from the nozzle 12 of the nozzle head 11 to print a hydrodynamic groove pattern comprising the demarcation portion Ba and hydrodynamic groove Bb on the upper end face 2b1 of the material 2b′. In this constitutional example, printing is carried out in response to the rotation of the material 2b′ in such a manner that it gradually proceeds in the circumferential direction. When a printed part proceeds to a certain degree in the circumferential direction (halfway in the example shown in the FIG.) and the printed part reaches a region opposing the light source 14, the ink which has received the ultraviolet irradiation causes a polymerization reaction to be cured.

In the example shown in the FIG., the case where one nozzle head 11 is used is shown as an example, but this can be also disposed a plurality of positions in the radial direction or circumferential direction. Furthermore, the hydrodynamic groove pattern may be printed throughout its entire surface while the material 2b′ makes a full single rotation, or the material 2b′ may be rotated more time, for example, two to a few ten rotations, so that the hydrodynamic groove pattern can be formed on the entire material 2b′.

FIG. 6 conceptionally shows a constitutional example of a spindle motor for information appliances integrating a hydrodynamic bearing apparatus (fluid hydrodynamic bearing apparatus) 1. This spindle motor for information appliances is used for disk drive units such as HDD, and comprises the hydrodynamic bearing apparatus 1, a rotor (hereinafter referred to as disk hub 3) attached to the shaft member 2 of the hydrodynamic bearing apparatus 1, for example, stator coils 4 opposing each other across a gap in the radial direction, a rotor magnet 5 and a bracket 6. The stator coils 4 are attached to the outer periphery of the bracket 6, and the rotor magnet 5 is attached to the inner periphery of the disk hub 3. The disk hub 3 retains one or a plurality of disks D such as magnetic disks on its outer periphery. A housing 7 is attached on the inner periphery of the bracket 6. When the stator coils 4 are energized, the rotor magnet 5 is rotated by the electromagnetic force produced, and accordingly the disk hub 3 and shaft member 2 are rotated.

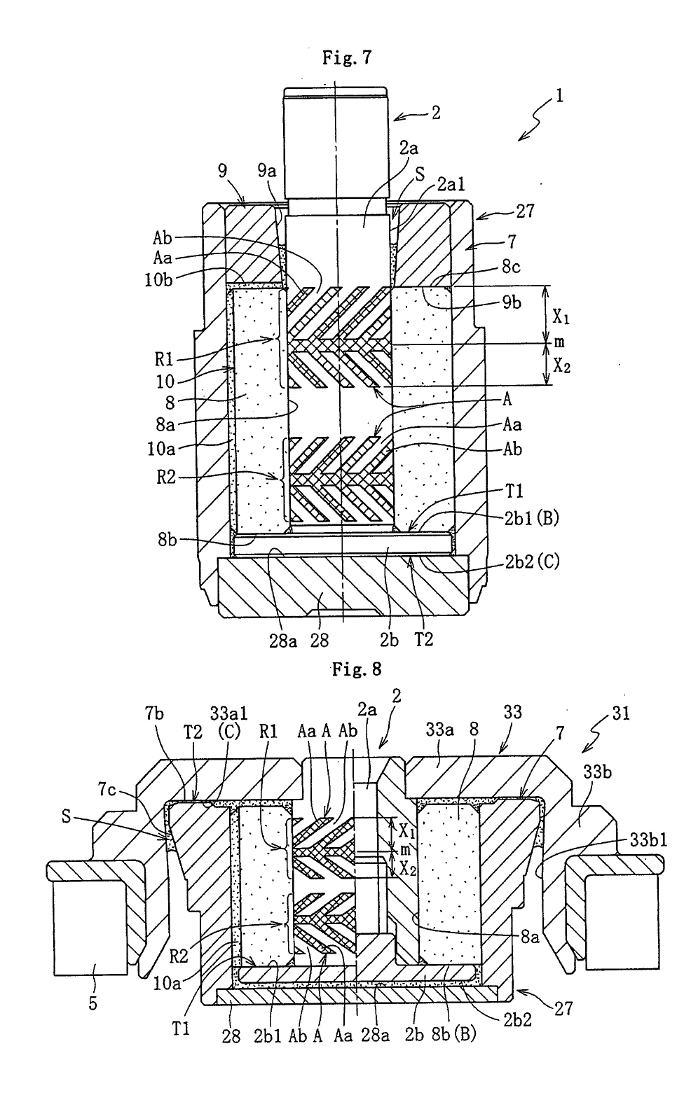

An example of the hydrodynamic bearing apparatus 1 used in the above spindle motor is shown in FIG. 7. This hydrodynamic bearing apparatus 1 includes, as main constitutional components, a bearing component 27 having a sleeve-like part, a shaft member 2 inserted at the inner periphery of the bearing component 27, a lid member 28 which closes one end opening portion of the bearing component 27, and a sealing member 9. In this form, the bearing component 27 is constituted of the bearing sleeve 8 and a cylindrical housing 7 having the bearing sleeve 8 fixed on its inner periphery. It should be noted that for the sake of explanation, the side sealed by the sealing member 9 of the housing 7 is referred to as the upper side, and the side sealed by the lid member 28 of the housing 7 is referred to as the lower side in the following description.

The shaft member 2, for example, is made of a metallic material such as stainless steel, and is constituted of the shaft portion 2a and a flange portion 2b integrally or separately provided at its one end. On the outer circumferential surface 2a1 of the shaft portion 2a, as a hydrodynamic pressure producing part, for example, a radial bearing face A including a hydrodynamic groove Ab arranged in a herringbone shape, a demarcation portion Aa forming and demarcating the hydrodynamic groove Ab is formed at two positions away from each other. On upper radial bearing face A, the hydrodynamic groove Ab is formed axially asymmetrically relative to the axial center m, an axial dimension X1 of the region above from the axial center m is larger than the axial dimension X2 of the region below the center m. Accordingly, when the shaft member 2 is rotated, the drawing force of a lubricating oil (pumping force) of upper radial bearing face A is greater than that of the lower symmetrical radial bearing face A. It should be noted that the number of the radial bearing face A formed can be optional, and it may be formed in one position or three positions or more in the axial direction.

On the upper end face 2b1 of the flange portion 2b of the shaft member 2, as a hydrodynamic pressure producing part, for example, a hydrodynamic groove Bb arranged in the spiral shape as shown in FIG. 3 by the above ink jet printing and a first thrust bearing face B including a demarcation portion Ba forming and demarcating the hydrodynamic groove Bb are formed. Moreover, for example, a hydrodynamic groove arranged in a spiral shape by the above ink jet printing as the upper end face 2b1, a second thrust bearing face C (not shown) including a demarcation portion demarcation portion Ba forming and demarcating the hydrodynamic grooves are formed on the lower end face 2b2 of the flange portion 2b.

It should be noted that in the radial bearing face A formed on the outer circumferential surface 2a1 of the shaft portion 2a, the hydrodynamic pressure producing part can be formed by ink jet printing as the upper end face 2b1 and lower end face 2b2 of the flange portion 2b. Otherwise, radial bearing face A can be formed by rolling processing, forging processing, press processing and like plastic processing method or a machining method such as cutting.

The bearing sleeve 8 is formed, for example, of a porous body which is an oil-containing sintered metal of a porous body made of a sintered metal, especially a sintered metal comprising copper as a main component impregnated with a lubricating oil (or lubricating grease). The shaft member 2 is inserted at the inner periphery face 8a of the bearing sleeve 8. In this constitutional example, the lower end face 8b of the bearing sleeve 8 is formed as a smooth and flat surface, and the inner periphery face 8a is formed as a completely round cylindrically curved surface.

The housing 7 is cylindrically formed from a resin material or metallic material. An opening portion at the lower end of the housing 7 is closed with a lid member 28 formed from a metallic material such as a soft metal or a resin material. The lid member 28 is fixed to the opening portion at the lower end of the housing 7 by a fixing means such as press fitting and adhesion. Otherwise, the housing 7 and lid member 28 can be integrally formed from a metallic material or a resin material.

The sealing member 9 is cylindrically formed from a metallic material or a resin material cyclic. The sealing member 9 is formed separately from the housing 7, and is fixed by a means such as press fitting, adhesion the upper end opening portion of the housing 7. The diameter of the inner periphery face 9a of the sealing member 9 becomes larger towards the top in a tapering manner. Between this inner periphery face 9a and, the outer circumferential surface 2a1 of the shaft portion 2a opposing the inner periphery face 9a, an annular sealing space S which becomes gradually wider towards the top is formed. In an inner space of the hydrodynamic bearing apparatus 1 sealed by the sealing member 9, for example, a lubricating oil is poured as a lubricating fluid, and the inside of the hydrodynamic bearing apparatus 1 is filled with the lubricating oil. In this state, the oil level of the lubricating oil is maintained within the range of the sealing space S. To reduce the number of parts and assembly man-hour, the sealing member 9 can be formed integrally with the housing 7.

In the hydrodynamic bearing apparatus 1 having the above constitution, when the shaft member 2 rotates, the radial bearing face A of the outer circumferential surface 2a1 of the shaft portion 2 oppose the inner periphery face 8a of the bearing sleeve 8, respectively, across a radial bearing gap are. In response to the relative rotation, the lubricating oil filling each radial bearing gap produces the hydrodynamic effect, and the shaft member 2 is rotatably supported by the pressure in the radial direction in a non-contact manner. Accordingly, a first radial bearing portion R1 and a second radial bearing portion R2 which rotatably support the shaft member 2 in the radial direction in a non-contact manner are formed.

Moreover, a first thrust bearing face B formed on the upper end face 2b1 of the flange portion 2b of the shaft member 2 opposes the lower end face 8b of the bearing sleeve 8 across a first thrust bearing gap. The second thrust bearing face C formed on the lower end face 2b2 of the flange portion 2b opposes the upper end face 28a of the lid member 28 across the second thrust bearing gap. In response to the relative rotation of the shaft member 2 and bearing sleeve 8, the lubricating oil filling both thrust bearing gaps produces the hydrodynamic effect, and the shaft member 2 is rotatably supported by the pressure in the thrust direction in a non-contact manner. Accordingly, a first thrust bearing portion T1 and a second thrust bearing portion T2 which rotatably support the shaft member 2 in both thrust direction s in a non-contact manner are formed.

When an unbalance occurs in the pressures of the thrust bearing gaps of both thrust bearing portions T1, T2 and the sealing space S while this hydrodynamic bearing apparatus is in operation, the lubricating oil flows through a circulation path 10 which communicates both spaces. Therefore, the difference in the pressures is resolved at an early stage, formation of bubbles and leakage of the lubricating oil in the lubricating oil resulting from the difference in the pressures, and generation of vibration are inhibited. In FIG. 7, the case where the circulation path 10 is constituted of an axial groove 10a comprising the outer circumferential surface of the bearing sleeve 8 formed thereon, a radial groove 10b formed the lower end face 9b of the sealing member 9 is shown as an example, but the axial groove 10a may be formed on the inner periphery face of the housing 7, and the radial groove 10b may be formed on the upper end face 8c of the bearing sleeve 8.

It should be noted that in the above description, the case where thrust bearing faces B, Care formed both end faces 2b1, 2b2 of the flange portion 2b by ink jet printing is shown as an example, but the thrust bearing faces B, C formed by ink jet printing can be formed on the faces which oppose on both end faces of the flange portion 2b, for example, the lower end face 8b of the bearing sleeve 8 constituting the bearing component 27 and the upper end face 28a of the lid member 28. Among the two thrust bearing faces B, C, the hydrodynamic groove pattern of either of the thrust bearing face can be formed by another processing method such as press processing.

The present invention can be applied not only to the hydrodynamic bearing apparatus 1 shown in FIG. 7 but also to other hydrodynamic bearing apparatuses as well shown below as examples. It should be noted that in the description below, the components and elements having identical functions as in the constitutional example shown in FIG. 7 basically are denoted by common reference numerals and repeated explanation is dispensed with.

The hydrodynamic bearing apparatus 31 shown in FIG. 8 differs from the hydrodynamic bearing apparatus 1 shown in FIG. 7 in that the tapering sealing space S is formed between the inner periphery face 33b1 of the disk hub 33 and the outer circumferential surface 7c of the housing 7, and that second thrust bearing portion T2 is formed between the upper end face 7b of the housing 7 and the lower end face 33a1 of the disk hub 33. In the first thrust bearing portion T1, the thrust bearing face B which has been subjected to ink jet printing is formed on the lower end face 8b of the bearing sleeve 8 which is a part of the bearing component 27. In the second thrust bearing portion T2, the thrust bearing face C which has been subjected to ink jet printing is formed on the lower end face 33a1 of the disk hub 33 as a rotor. It is also possible to form the thrust bearing face B on the upper end face 2b1 of the flange portion 2b and the thrust bearing face C on the upper end face 7b of the housing 7 constituting the bearing component 27, respectively.

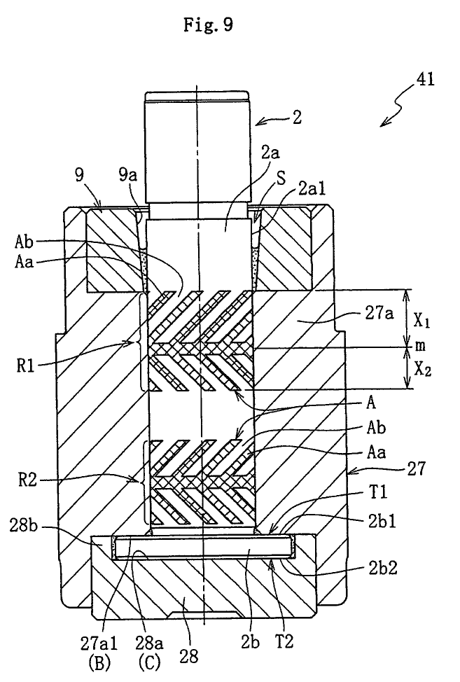

The hydrodynamic bearing apparatus 41 shown in FIG. 9 differs from the hydrodynamic bearing apparatus 1 shown in FIG. 7 in that the bearing component 27 is constituted integrally of the bearing sleeve 8 and housing 7, a cylinder member 28b protruding upward is provided on the outer periphery of the lid member 28, and that this cylinder member 28b is brought into contact with the end face 27a1 of a sleeve member 227a corresponding to the bearing sleeve 8 of the bearing component 27. At the first thrust bearing portion T1, the thrust bearing face B which has been subjected to ink jet printing is formed on the end face 27a1 of the sleeve member 227a of the bearing component 27, while in the second thrust bearing portion T2, the thrust bearing face C which has been subjected to ink jet printing is formed on the upper end face 28a of the lid member 28. The thrust bearing face B may be on the upper end face 2b1 of the flange portion 2b, and the thrust bearing face C may be formed on the lower end face 2b2 of the flange portion 2b.

In the above embodiment, a bearing in which the hydrodynamic pressure producing part comprising the hydrodynamic grooves having, for example, a herringbone shape or a spiral shape as the hydrodynamic bearing constituting the radial bearing portions R1, R2 and thrust bearing portions T1, T2 is used. However, the constitution of the hydrodynamic pressure producing part is not limited to this. For example, as the radial bearing portions R1, R2, so-called step bearings and multilobe bearing s can be employed. A step bearing is such a bearing in which a plurality of hydrodynamic grooves in the shape of axial grooves are provided in the circumferential direction at a predetermined interval in a region which serves as a radial bearing face, and a multilobe bearing is such a bearing in which a plurality of arcuate faces which contracts a bearing gap in one or both circumferential directions in a wedge shape are provided on the inner periphery face 8a of the bearing sleeve 8 and on the outer circumferential surface 2a1 of the shaft portion 2a.

Moreover, one or both of the thrust bearing portions T1, T2 can be, for example, constituted of a step bearing, or can be constituted of a so-called wave bearing (step shape is in a wave shape) or the like.

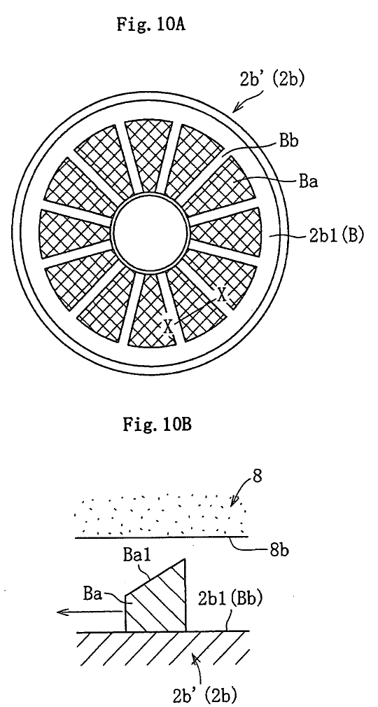

FIG. 10A shows an example of a bearing in which a step-type bearing face is constituted on the upper end face 2b1 of the material 2b′. In the example shown in the FIG., a plurality of hydrodynamic grooves Bb in the shape of radial grooves are provided in the circumferential direction at a predetermined interval, and the demarcation portion Ba forming and demarcating said hydrodynamic grooves Bb is formed by the above ink jet printing method. The upper face Ba1 of the demarcation portion Ba is tapered as shown in FIG. 10B. At this portion, the thrust bearing gap is in a wedge shape. In response to the rotation of the flange portion 2b (shaft member 2) n the direction of the arrow in the FIG. The lubricating oil is pressed towards a narrower side of the wedge-shaped gap. Therefore, in accordance with its hydrodynamic effect, the shaft member 2 is supported in the thrust direction in a non-contact manner so that the first thrust bearing portion T1 is formed.

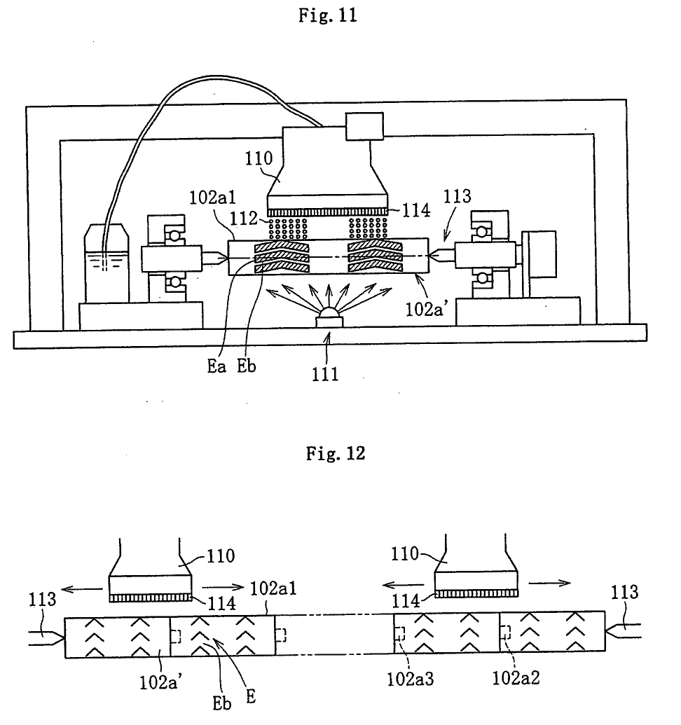

The second embodiment of the present invention will be described referring to FIGS. 11-18.

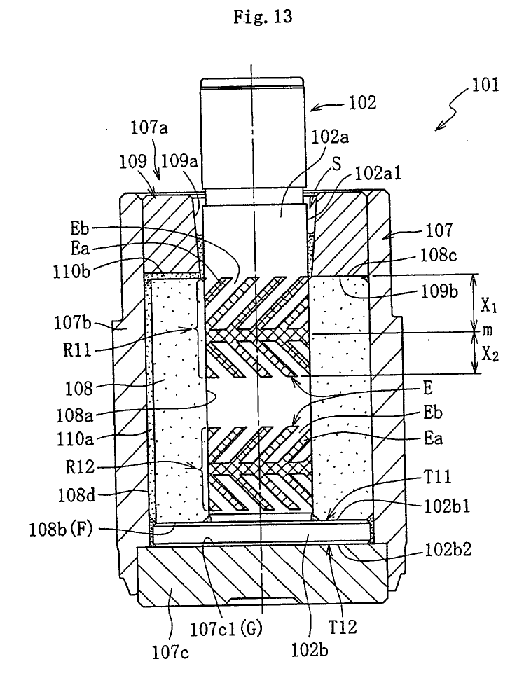

According to the second embodiment of the present invention, as a method of molding a hydrodynamic pressure producing part, the shaft member 102 shown in FIG. 13 is taken as an example of the steps of forming a hydrodynamic pressure producing part on the outer circumferential surface 102a1 of this shaft portion 102a.

In this embodiment, the hydrodynamic pressure producing part formed on the outer circumferential surface 102a1 of the shaft portion 102a is formed by undergoing the cleaning step (a) of the outer circumferential surface of the shaft portion, a printing step (b) of providing the ink on to the outer circumferential surface of the shaft portion, and a curing step (c) in which the provided ink is cured.

(a) Cleaning Step

Firstly, the surface of the material which constitutes the hydrodynamic pressure producing part and to which the ink is to be provided is cleaned. In this embodiment, as the material 102a′ of the shaft portion 102a, a metal such as stainless steel formed into a shaft-like shaped by machining such as grinding is used. Moreover, as a cleaning means, acid cleaning using a hydrochloric acid is employed.

The material 102a′ is placed into a container filled with a hydrochloric acid in a predetermined concentration, the surface (especially the outer circumferential surface 102a1) of the material 102a′ is immersed in a hydrochloric acid solution under the effect of ultrasound waves. After a predetermined immersion time elapses, the material 102a′ is removed from the hydrochloric acid solution, and the hydrochloric acid deposited on the surface is removed, for example, in ultrapure water by ultrasound wave cleaning or other means.

Accordingly, impurities such as cutting powders, oils and fats deposited the outer circumferential surface 102a1 of the material 102a′ are removed. Moreover, an oxide film formed on the outer circumferential surface 102a1 of the material 102a′ made of stainless steel is removed. Accordingly, the surface condition of the outer circumferential surface 102a1 becomes good and uniform.

(b) Printing Step and (c) Curing Step

FIG. 11 shows the summary of the printing apparatus of the hydrodynamic pressure producing part by the ink jet method. This printing apparatus serves as a form for continuously carrying out a printing step (b) in which a minute amount of the ink is provided and a curing step in which the provided ink is cured (c). As shown in FIG. 11, this printing apparatus mainly comprises a rotationally drive 113, a single or plurality of nozzle heads 110 opposing the outer circumferential surface 102a1 of the material 102a′ rotationally driven by the rotationally drive 113, a curing member 111 disposed with its position in the circumferential direction relative to the nozzle head 110 differed, preferably as shown in FIG. 11, disposed opposing the nozzle head 110 across the material 102a′. A plurality of nozzles 114 which discharge a minute amount of the droplet-like ink 112 at the nozzle head 110 are set up in the axial direction. The row of these nozzles 114 provided may be one or a plurality of rows in the direction perpendicular to the material 102a′. The ink 112 is, for example, a resin composition based on a light curable resin, preferably ultraviolet curable resin. If necessary, an organic solvent, for example, that containing a photopolymerization initiator in an appropriate amount is used. The curing member 111 is a light source which irradiates the light for curing the ink 112. For example, an ultraviolet lamp is used.

Examples of an ultraviolet curable resin for constituting the ink 112 include radical polymerizable monomers, radical polymerizable oligomers and cationic polymerizable monomer, as well as en-thiol compounds typically including imide acrylate, cyclic polyene compounds and polythiol compounds. Among these, radical polymerizable monomers, radical polymerizable oligomers and cationic polymerizable monomers are suitably usable. These ultraviolet curable resins used may be used singly or in combination of two or more kinds. Moreover, the above single kind of resin, or a resin mixture of two or more kinds can be used as a base resin.

In these base resins, radical photopolymerization initiators and photopolymerization initiators such as cationic photopolymerization initiators can be used. As these photopolymerization initiators can also be used singly or in combination of two or more kinds.

In the above constitution, in the state that the material 102a′ is rotationally driven, the ink 112 is discharged from the nozzle 114 so that a minute amount of the ink 112 in droplets lands on a predetermined position of the outer circumferential surface 102a1 of the material 102a′. By gathering much of a minute amount of the ink 112 forming this droplet, a plurality of hydrodynamic grooves Eb arranged for example, in a herringbone shape as the hydrodynamic pressure producing part on the outer circumferential surface 102a1 of the material 102a and a hydrodynamic groove pattern (a region serving as the radial bearing face E) having the demarcation portion Ba forming and demarcating the hydrodynamic grooves Eb is formed (refer to FIG. 11 or FIG. 13). In this embodiment, only the demarcation portion Ea is formed from the aggregates of the above minute amount of the ink 112.

In this embodiment, printing of the hydrodynamic groove pattern is carried out in such a manner that it proceeds gradually in the circumferential direction in response the rotation of the material 102a′. When the printed part reaches a region opposing of the curing member 111 (in FIG. 11, when the halfway from the position opposing the nozzle head 110 is reached), the ink 112 which has received the ultraviolet irradiation causes a polymerization reaction to be sequentially cured. While the supply and stop the ink 112 of each from the nozzle 114 are appropriately switched, the material 102a′ is rotated once to less than one hundred times, of the material 102a′ and the demarcation portion Ea constituting the hydrodynamic pressure producing part is formed throughout its circumference. At this time, since the nozzle head 110 and the curing member 111 are disposed at the position opposing each other across the material 102a′, the ultraviolet ray irradiated from the curing member 111 is screened by the material 102a′, and therefore the curing action of the polymerization reaction to the ink 112 discharged from the nozzle 114 is not exerted. Therefore, clogging or the like of the nozzle 114 by the cured ink 112 can be prevented so that the demarcation portion Ea (and hydrodynamic groove Eb) can be efficiently formed.

In this printing, the nozzle head 110 may be disposed at a fixed position, or may be slid in the axial direction of the material 102a′. Moreover, in FIG. 11, the case where a single nozzle head 110 is used is shown as an example, but this can be disposed at a plurality of positions in the axial direction or circumferential direction. Moreover, for example, as shown in FIG. 12, while a plurality of the materials 102a′ are serially coupled and rotated simultaneously, they are slid in the axial direction by one or a plurality of the nozzle heads 110 so that the hydrodynamic groove pattern can be formed on each material 102a′. In this case, the coaxiality among the material 102a′ can be ensured by, for example, fitting a projection 102a2 provided at one shaft end and a recess 102a3 at the other shaft end. Moreover, in this embodiment, the case where the material 102a′ is rotationally driven is described, but the material 102a′ may be fixed and the nozzle head 110 and curing member 111 may be rotationally driven about the material 102a′.

Thus, in the ink jet method, a minute amount of the ink 112 in a droplet-like shape in conformity with preliminarily programmed shape pattern is discharge with its output rate correctly adjusted. In addition, in the cleaning step (a), the outer circumferential surface 102a1 of the material 102a is cleaned by acid cleaning, and its surface condition is uniformly improved throughout its entire surface. Therefore, a minute amount of the ink 112 which lands and drops on the outer circumferential surface 102a1 of the material 102a forms a uniform shape, for example, forms a uniform contact angle between the outer circumferential surface 102a1 and itself after landing, and the hydrodynamic groove pattern formed by the aggregates of these minute amount of the ink 112 can be formed highly accurately. In addition, according to this type of molding method, the cured ink 112 itself can ensure a required depth (a few μm to a few ten μm) of the hydrodynamic grooves. This can dispense with carrying out a lathe process, etching or the like after the printing, allowing the material to be used as it is as the shaft member 102 with the hydrodynamic pressure producing part.

As the outer circumferential surface 102a1 of the material 102a, on which the cleaning process stated above is carried out, is formed by, for example, machining such as grinding, lines in the grinding direction caused in grinding may remain depending on the degree of the surface roughness after processing. These lines are never preferable because they may cause a flow along the lines from the position where the ink 112 provided in the form of drops is to be fixated. As mentioned above, this type of problem can be solved by cleaning with an acid, especially hydrochloric acid. however, if a cleaning time (as for acids, immersion time) is too long, the cycle time is increased and the surface of the material 102a′ is overly dissolved, resulting in a rather worsened surface condition (for example, surface roughness). Accordingly, the cleaning time needs to be suitably selected depending on the cleaning force (dissolving power) of the cleaning means employed. As a guide, the surface roughness Ra of the outer circumferential surface 102a1 after cleaning is 0.05 μm or lower, more preferably 0.03 μm or lower.

Moreover, in this embodiment, the case where the printing step (b) and curing step (c) are carried out after the cleaning step (a), but for example, a surface treatment step by a coupling agent can be inserted between the cleaning step (a) and printing step (b). This forms a coating (not shown) made of a coupling agent on the outer circumferential surface 102a1 of the material 102a prior to supply of the ink 112 in the form of drops and after cleaning of the outer circumferential surface 102a1. This type of coating formation (surface treatment) can be carried out by feeding a coupling agent which is diluted to a predetermined concentration (0.1 to 5% by weight) for example, with an alcohol or a mixed solution of an alcohol and water or a solvent such as toluene, to the outer circumferential surface 102a1 of the material by the means such as spraying method or dipping method. The above coupling agent used may be any of various substances. Considering the industrial stability, titanate-based coupling agents can be desirably used. Thus, prior to the printing of the hydrodynamic pressure producing part with the ink 112, a coating made of a coupling agent on the outer circumferential surface 102a1 of the material 102a is formed, whereby with originally poor adhesion the adhesion between an inorganic material such as metals and an organic material such as an ink can be improved. Therefore, after the ink 112 is cured, peeling and falling out are likely to be caused by the sliding contact with bearing components, the shape of the hydrodynamic pressure producing part can be stably retained for a long period. In particular, as in this embodiment, a surface treatment is performed by a coupling agent on the surface of the material 102a′ which has been subjected to cleaning process with hydrochloric acid, whereby the event of partial formation failure of the coating made of the coupling agent can be avoided and this type of coating can be formed uniformly and securely on the outer circumferential surface 102a1.

It should be noted that in this embodiment, the case where cleaning by an acid such as hydrochloric acid is employed as a cleaning means of the material 102a′, but UV cleaning, ozone cleaning, or the combination of both cleaning processes can be also employed. Since these cleaning methods are feasible in dry circumstances, the troubles of removing the acid deposited on the surface of the material 102a′ after the cleaning process or drying moisture deposited on the outer circumferential surface 102a1 of the material in association with removal as in acid cleaning can be dispensed with, leading to the simplification of the work steps.

The case where the hydrodynamic pressure producing part is formed by printing on the outer circumferential surface 102a1 of the shaft portion 102a (material 102a′) above is described above. The above-mentioned method is also applicable to the case where the hydrodynamic pressure producing part is formed by printing on the inner periphery face of a bearing component (in FIG. 13, corresponds to the bearing sleeve 108. hereinafter refer to FIG. 13 for each constitutional component.) constituting a hydrodynamic bearing between the shaft member 102 and the bearing component. Otherwise, by a similar method, the hydrodynamic pressure producing part (for example, hydrodynamic groove) for producing hydrodynamic pressure in the thrust direction can be formed for example, at the flange portion 102b of the shaft member 102, the end face of the bottom 107c of the housing 107 or the like.

Moreover, in the above description, the case where the ink jet system is employed as the fixing system of the ink 112 is described, but it is not limited to this system and, for example, a system which discharges droplets and cause them to land utilizing, a so-called nozzleless type system for discharging droplets, a system which discharges the ink via a micropipette not in droplets but successively onto the surface of the material, a system in which the distance to the surface of the material is shortened and the ink is discharged and brought into contact with on the fixation surface simultaneously or the like can be employed.

The shaft member 102 produced by undergoing the above step constitutes a hydrodynamic bearing, for example, using this shaft member 102 and a bearing component which produces the hydrodynamic effect of a fluid in a bearing gap between itself and the shaft member 102 to support the shaft member 102 in a non-contact manner. An constitutional example of the hydrodynamic bearing apparatus integrating the shaft member 102 is described below referring to the FIGS.

FIG. 13 show a first constitutional example of the hydrodynamic bearing apparatus 101 integrating the shaft member 102 produced by undergoing the above steps. This hydrodynamic bearing apparatus 101 comprises the shaft member 102 having the shaft portion 102a at its rotational center, a bearing sleeve 108 having the inner periphery at which the shaft member 102 can be inserted, the housing 107 comprising the bearing sleeve 108 fixed on inner periphery, the sealing member 109 provided at one end on the opening side of the housing 107. In this embodiment, the bearing component is constituted of the housing 107 and bearing sleeve 108. It should be noted that for the sake of explanation, the side of the sealing member 109 is referred to as the upper side, and the side opposite to the sealing member 109 in the axial direction is referred to as the lower side in the description provided below.

The shaft member 102 has the shaft portion 102a and the flange portion 102b integrally or separately provided at one end of the shaft portion 102a. On the outer circumferential surface 102a1 of the shaft portion 102a, for example, a plurality of hydrodynamic grooves Eb arranged in a herringbone shape and a radial bearing face E including demarcation portion Ba forming and demarcating each hydrodynamic groove Eb are formed as a radial hydrodynamic pressure producing part at two separate positions in the axial direction. On the upper radial bearing face E, the hydrodynamic grooves Eb are formed asymmetrically in the axial direction relative to the axial center m (the axial center of a region between the upper and lower slanted grooves), and an axial dimension X1 of the region above from the axial center m is larger than the axial dimension X2 of the region below the center m.

The bearing sleeve 108 is formed, for example, in a cylindrical shape from a non-porous body of a soft metal such as Cu (including Cu alloys) and Al (including Al alloys), or a porous body of a sintered metal. The inner periphery face 108a of the bearing sleeve 108 becomes a smooth and cylindrically curved surface. Although not shown in the FIGS., a plurality of hydrodynamic grooves arranged for example, in a spiral shape as a thrust hydrodynamic pressure producing part and the first thrust bearing face F including demarcation portion Ba forming and demarcating these hydrodynamic groove are formed in an annular region of the lower end face 108b of the bearing sleeve 108 entirely or partially. It should be noted that a herringbone shape can be also employed as the arrangement pattern of the hydrodynamic grooves.

The housing 107 comprises an approximately cylindrical side portion 107b, a bottom 107c positioned at the lower end of the side portion 107b and provided integrally with or separately from the side portion 107b. In this embodiment, the bottom 107c is formed as a separate component from the side portion 107b both from a metal, and is fixed by means such as adhesion (including loose adhesion, press fitting adhesion), press fitting, welding (for example, ultrasonic welding), welding (for example, laser welding) at the lower end of the side portion 107b. Either the side portion 107b or the bottom 107c can be of course formed of a resin, or both can be formed of a resin.

In the entire or partial annular region of the upper end face 107c1 of the bottom 107c, a first thrust bearing face G including a plurality of hydrodynamic grooves arranged, for example, in a spiral shape although not shown in the FIGS. as the thrust hydrodynamic pressure producing part and a demarcation portion forming and demarcating these hydrodynamic grooves is formed. It should be noted that a herringbone shape can be also employed as the arrangement pattern of the hydrodynamic grooves.

On the inner periphery of the opening portion 107a of the housing 107, an annular sealing member 109 formed from a metallic material or a resin material is fixed by means such as press fitting, adhesion and welding. The inner periphery face 109a of the sealing member 109 gradually becomes wider in the axial direction towards the top in a tapering manner. A sealing space S whose radial dimension is increased gradually towards the top is formed between the inner periphery face 109a and the outer circumferential surface 102a1 of the shaft portion 102a opposing it.

A lubricating oil fills the inside of the hydrodynamic bearing apparatus 101 having the above constitution (dotted region in FIG. 13), and the oil level of the lubricating oil is always maintained within the sealing space S. It should be noted that to reduce the number of parts and assembly man-hour, the sealing member 109 can be formed integrally with the housing 107 (including insert molding, outsert molding). Alternatively, instead of the sealing member 109, a region on the upper end opening side of the inner periphery face 108a of the bearing sleeve 108 can be formed so as to have a larger diameter than a region which serves as the radial bearing face, or formed to become gradually wider, so that a sealing space is formed between the region and the outer circumferential surface 102a1 of the shaft portion 102a opposing this region.

When the shaft member 102 is in rotation, the radial bearing face E of the outer circumferential surface 102a1 of the shaft member 102 (the region in which the two upper and lower hydrodynamic grooves Eb are formed) oppose the inner periphery face 108a of the bearing sleeve 108 across the radial bearing gap. With the rotation of the shaft portion 102a, the lubricating oil in the above radial bearing gap pushed to the axial center side of the hydrodynamic grooves Ebon each radial bearing face E, which increases the pressure. A first radial bearing portion R11 and a second radial bearing portion R12 which support the shaft portion 102a by such a hydrodynamic effect of the hydrodynamic grooves Eb in the radial direction in a non-contact manner are constituted, respectively.

Simultaneously, an oil film of the lubricating oil is formed by the hydrodynamic effect of the hydrodynamic grooves in the thrust bearing gap between the thrust bearing face F of the bearing sleeve 108 (the region in which the hydrodynamic grooves are formed) and the upper end face 102b1 of the flange portion 102b opposing it, and the thrust bearing gap between the thrust bearing face G of the bottom 107c and the lower end face 2b2 of the flange portion 102b opposing it. A first thrust bearing portion T11 and second thrust bearing portion T12 which support the flange portion 102b in the thrust direction in a non-contact manner are constituted by the pressure of this oil film.

It should be noted that in this hydrodynamic bearing apparatus 101, during the rotation of the shaft member 102, the lubricating oil positioned in the radial gap between the shaft member 102 and bearing sleeve 108 is pushed to the side of the bottom 107c of the housing 107. Therefore, the pressure in the thrust bearing gap of the thrust bearing portions T11, T12 as it is overly increased, leading to possible formation of bubbles in the lubricating, the leakage of the lubricating oil, or generation of vibration. In this case, a communication path which communicates the thrust bearing gap (especially the thrust bearing gap of the first thrust bearing portion T11) and the sealing space S can be provided so that the lubricating oil flows between the thrust bearing gap and sealing space S through this type of communication path. Therefore, such difference in pressures is resolved at an early stage and the above-mentioned adverse effects can be prevented. In FIG. 13, as an example, the case where a communication path 110a is formed on the outer circumferential surface 108d of the bearing sleeve 108 and a communication path 110b is formed on the lower end face 109b of the sealing member 109 is shown.

By the way, in this embodiment, first thrust bearing face F is on the lower end face 108b of the bearing sleeve 108 and the second thrust bearing face G is formed on the upper end face 107c1 of the bottom 107c of the housing 107. These thrust bearing faces F, G can be formed on the side of the face opposing these (both end faces 102b1, 102b2 of the flange portion 102b. It should be noted that each thrust bearing face F, G can be formed by not only by molding, but also by undergoing the cleaning step→sprinting and curing step of the hydrodynamic pressure producing part, or cleaning step→surface treatment step by a coupling agent→printing and curing step of the hydrodynamic pressure producing part as the radial bearing face E.

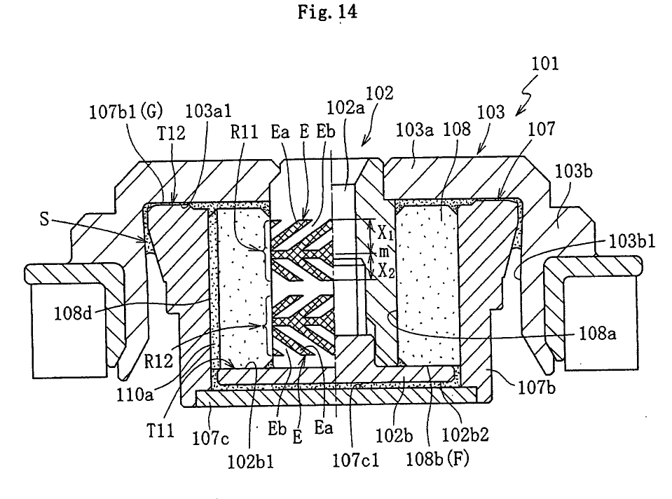

The constitution of the shaft member 102 comprising the hydrodynamic pressure producing part according to the present invention is not limited to that mentioned above, but the shaft member can be used for hydrodynamic bearing apparatuses having other constitutions. In the hydrodynamic bearing apparatus described below in FIGS. 14-16, sites and components the same constitution and action as in the first constitutional example shown in FIG. 13 are denoted by the identical reference numerals, and repeated explanation is dispensed with. It should be noted that all the forms described below, the radial bearing face E having the hydrodynamic pressure producing part is formed by the above ink jet method on the outer circumferential surface 102a1 of the shaft portion 102a of the shaft member 102.

FIG. 14 shows another constitutional example of the hydrodynamic bearing apparatus 101. The constitution of the hydrodynamic bearing apparatus 101 in the same FIG. differs from that of the hydrodynamic bearing apparatus according to the first constitutional example mainly in that, the sealing space S is formed on the side of the outer diameter of the housing 107, and that the second thrust bearing portion T12 is formed between the upper end face 107b1 of the side portion 107b of the housing 107 and the lower end face 103a1 of a plate member 103a constituting a disk hub 103.

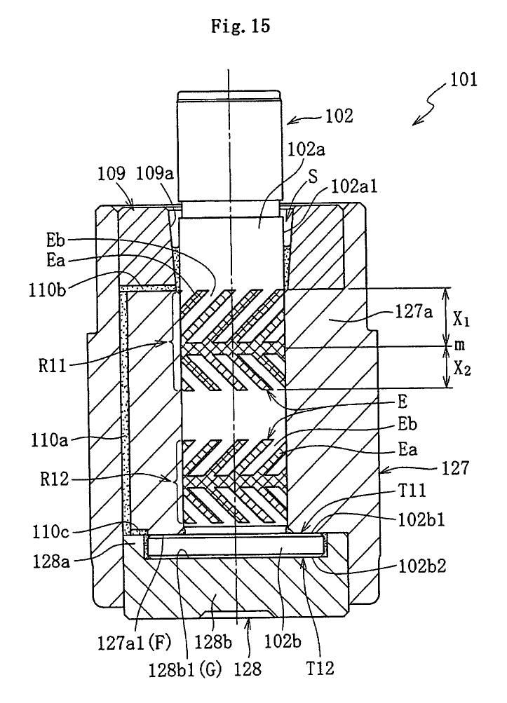

FIG. 15 shows another constitutional example of the hydrodynamic bearing apparatus 101. The constitution of the hydrodynamic bearing apparatus 101 in the same FIG. differs from that of the hydrodynamic bearing apparatus according to the first constitutional example mainly in that the bearing component is constituted of the integration of the bearing sleeve 108 and the housing 107 (bearing component 127), and that a cylinder member 128a protruding upward is provided on the outer periphery of the lid member 28 as the bottom and this cylinder member 128a is in contact with the lower end face 127a1 of a small-diameter cylinder member 127a corresponding to the bearing sleeve 108 of the bearing component 127. Thus, the number of parts and assembly man-hour can be reduced by conducting integration of the component parts of the bearing apparatus, enabling to achieve further cost reduction.

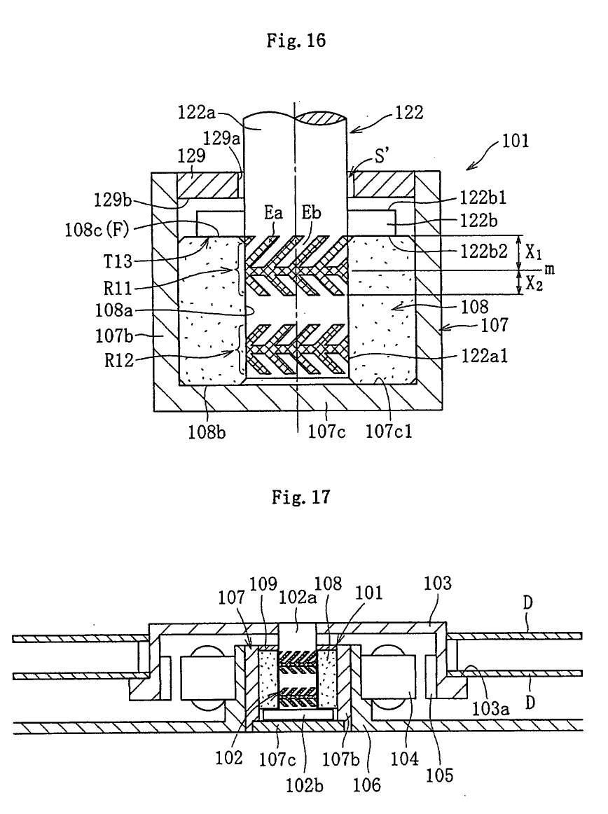

FIG. 16 shows another constitutional example of the hydrodynamic bearing apparatus 101. In this hydrodynamic bearing apparatus 101, the shaft member 122 is provided with a flange portion 122b above the lower end of the shaft portion 122a. During the rotation of the shaft member 122, the thrust bearing gap of the thrust bearing portion T13 is formed between the lower end face 122b2 of this flange portion 122b and the upper end face 108c of the bearing sleeve 108 opposing this. A sealing member 129 is fixed on the upper end inner periphery of the housing 107, and the sealing space S′ is formed between the inner periphery face 129a of the sealing member 129 and the outer circumferential surface 122a1 of the shaft member 122. The lower end face 129b of the sealing member 129 opposes the upper end face 122b1 of the flange portion 122b across the axial gap. At the time of upward displacement of the shaft member 122, it also has the slip-off prevention function of the shaft member 122 by engaging the upper end face 122b1 of the flange portion 122b.

By the way, the shape of the hydrodynamic pressure producing part included in the radial bearing face E shown in the constitutional example stated above is merely an example, and a hydrodynamic groove pattern corresponding to other groove arrangement configurations (for example, spiral shape) can be formed as long as the shape allows printing by the ink jet method. Additionally as the hydrodynamic pressure producing part included in the radial bearing face E, printing can be formed by a similar method in a so-called step-like hydrodynamic pressure producing part in which the grooves in the axial direction are formed at a plurality of positions in the circumferential direction, or a so-called multi-arc hydrodynamic pressure producing part in which a plurality of arcuate faces are formed in the circumferential direction, although not shown in the FIGS.

Moreover, in the above description, the case where the radial bearing face E is formed separately at two positions in the axial direction is shown as an example, but the number of the radial bearing faces E is optional and the radial bearing face E can be formed at one position or three positions or more in total.

Moreover, on the thrust bearing faces F, G, as the hydrodynamic pressure producing part, the above plurality of hydrodynamic grooves arranged in a spiral shape, a so-called step-like hydrodynamic pressure producing part in which a plurality of hydrodynamic grooves in the shape of radial grooves are provided in the circumferential direction at a predetermined interval, and a hydrodynamic pressure producing part forming a so-called wave shape (the step is in a wavy shape) an be formed.

Moreover, in the above embodiment, a lubricating oil is shown as an example of a fluid which fills the inside of the hydrodynamic bearing apparatus 101 and forms a lubricating film in each bearing gap. However, other fluids which can form a lubrication film in each bearing gap, for example, gases such as air, lubricants having fluidity such as magnetic fluids and lubricating grease can be used.

The hydrodynamic bearing apparatus 101 described above, for example, can be used in spindle motors integrated therein for information appliances represented by disk drive units such as HDD. FIG. 17 shows one constitutional example of it. This spindle motor comprises a hydrodynamic bearing apparatus 101, a disk hub 103 attached to the shaft member of the hydrodynamic bearing apparatus 101, a stator coil 104 and a rotor magnet 105 which oppose each other across a gap, for example, in the radial direction, and a motor bracket 106. The stator coil 104 is attached to the outer periphery of the motor bracket 106, and the rotor magnet 105 is attached to the inner periphery of the disk hub 103. The disk hub 103 retains one or a plurality of disks D such as magnetic disks on its outer periphery. When the stator coil 104 is energized, the rotor magnet 105 is rotated by the electromagnetic force produced between the stator coil 104 and the rotor magnet 105, which accordingly rotates the disk hub 103 and the disk D retained on the disk hub 103 integrally with the shaft member 102. This motor has both high durability and rotational accuracy.

### EXAMPLE 1

To establish the advantages of the present invention, by using a shaft member made of stainless steel (SUS420) as a material and immersing this material in two kinds of hydrochloric acids having different concentrations (15% by weight hydrochloric acid, 30% by weight hydrochloric acid), the surface of the material was subjected to a cleaning process. This cleaning wad carried out several times with different cleaning time (immersion times). After cleaning, the surface roughness of the surface of the material and its relationship with the immersion time were determined.

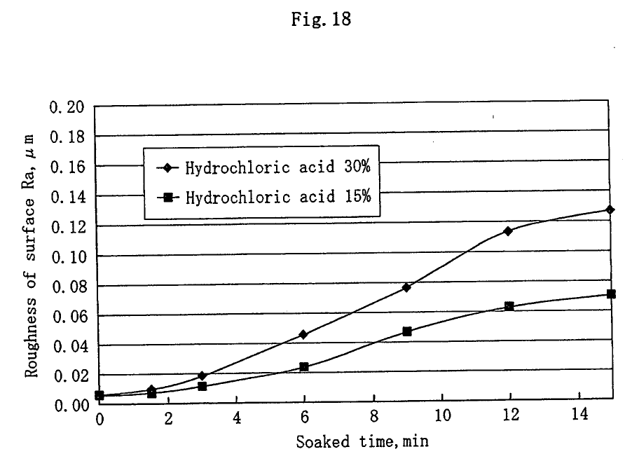

The results of the cleaning tests are shown in FIG. 18. The horizontal axis represents the immersion time [min], and the vertical axis represents the surface roughness Ra [μm] of the material. From the same FIG., in both cases of the hydrochloric acid concentrations, the surface roughness Ra increases with the immersion time. For example, the immersion time with which the surface roughness Ra=0.05 μm was about 9 minutes when the hydrochloric acid concentration was 15% by weight, while it was about 6 minutes when the hydrochloric acid concentration was 30% by weight.

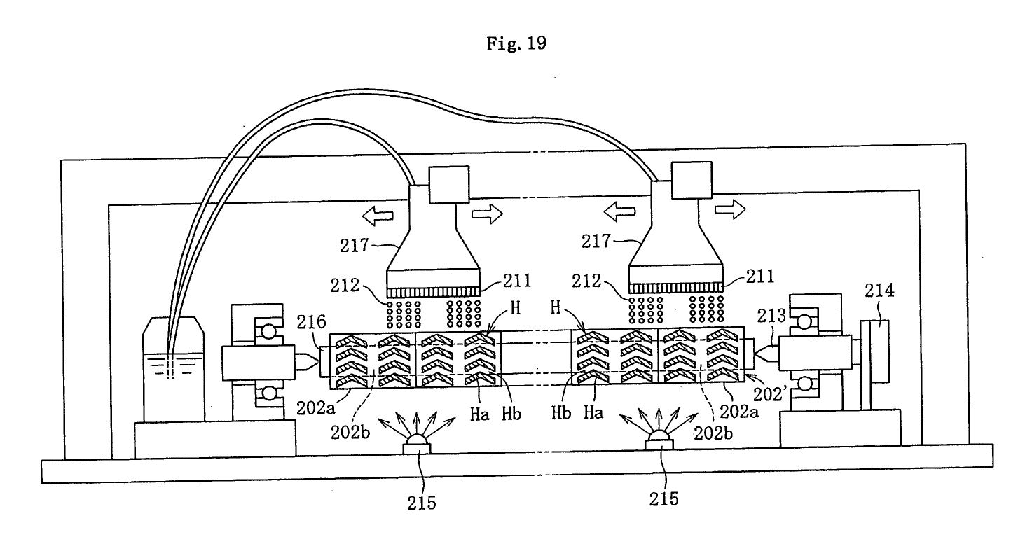

A third embodiment of the present invention will be described with reference to FIGS. 19 to 24 below.

A material 202′ constituting a shaft portion 202 is, for example, formed of a metallic material such as stainless steel. The material 202′ is formed into an approximately cylindrical shape having a through hole 202b which is in the axial direction and passing through its axis.

FIG. 19 shows, as an example of a method of forming a hydrodynamic pressure producing part according to the present invention, the summary of the hydrodynamic pressure producing part printing apparatus using the inkjet method. This printing apparatus has such a form that a printing step in which a minute amount of the ink is provided, a curing step in which the provided ink is cured.

As shown in the FIG., this printing apparatus comprises, as main components, one or a plurality of the nozzle heads 217 opposing a rotationally driven fixture 216 (the outer circumferential surface 202a of the material 202′, a supporting member 213 which supports both ends of the fixture 216 and rotationally drives the fixture, and one or a plurality of curing members 215 disposed differing its position in the circumferential direction relative to the nozzle head 217, preferably as shown in the FIG., disposed opposing the nozzle head 217 across the fixture 216. At least one of the supporting members 213 is provided with a rotation drive 214 such as a motor. It should be noted that in this embodiment, the nozzle heads 217 and the curing members 215 are each at two positions in the axial direction.

The fixture 216 is formed, for example, of a highly rigid metallic material such as stainless steel. A plurality of materials 202′ are serially connected on the outer circumferential surface of this fixture 216.

In the nozzle head 217, a plurality of nozzles 211 which discharge the microdroplets of the ink 212 are set up in the axial direction. The ink 212, for example, is a resin composition which comprises a light curable resin, preferably an ultraviolet curable resin as a base resin, a photopolymerization initiator. The resin composition used further contains, if necessary, of an organic solvent in an appropriate amount. The curing member 215 is a light source which irradiates a light for curing the ink 212. For example, an ultraviolet lamp is used.

Examples of the ultraviolet curable resin constituting the ink 212 used in the printing step include radical polymerizable monomers, radical polymerizable oligomers and cationic polymerizable monomer, as well as imide acrylate cyclic polyene compounds and en-thiol compounds, and polythiol compounds. Among these, radical polymerizable monomers, radical polymerizable oligomers and cationic polymerizable monomers can be favorably used. Examples of radical polymerizable monomers include monofunctional, bifunctional or multifunctional acrylate monomers, methacrylate monomers are usable. Examples of usable radical polymerizable oligomers include urethane acrylate, epoxy acrylate, polyester acrylate, and unsaturated polyesters. Moreover, examples of usable cationic polymerizable monomers include alicyclic epoxy resins, phenolic novolac epoxy resins, bisphenol A-based epoxy resins, 3-ethyl-3-(2-ethyl hexyloxymethyl)oxetane, 3-ethyl-3-hydroxymethyloxetane, 1,4-bis{[(3-ethyl-3-oxethanyl)methoxy]methyl}benzene, 3-ethyl-3-(phenoxymethyl)oxetane, di[1-ethyl (3-oxethanyl)]methylether, 3-ethyl-3-{[3-(triethoxysilyl)propoxymethyl}oxetane and like oxetane resins. These ultraviolet curable resin may be used as a base resin singly or in combination of two or more kinds.

For these base resins, radical photopolymerization initiators, cationic photopolymerization initiators and like photopolymerization initiators can be used. Examples of usable radical photopolymerization initiators include hydrogen abstraction type photopolymerization initiators typically including benzophenone, methyl ortho-benzoylbenzoate, 4-benzoyl-4′-methyldiphenyl sulfide, ammonium salts of benzophenone, isopropylthioxanthone, diethylthioxanthone, ammonium salts of thioxanthone. Alternatively, intramolecular cleavage type photopolymerization initiators typically including benzoin derivatives, benzyl dimethyl ketal, α-hydroxyalkylphenone, α-aminoalkylphenone, acylphosphine oxide, monoacylphosphine oxide, bis-acylphosphine oxide, acrylphenyl glyoxylate, diethoxyacetophenone, and titanocene compounds can be used. Moreover, examples of usable cationic photopolymerization initiators include polyaryl sulfonium salts such as triphenylsulfonium hexafluoroantimonate, triphenylsulfonium hexafluorophosphate, SP-170 and SP-150 (both manufactured by ASAHI DENKA KOGYO K.K.), FC-508 and FC-512 (both manufactured by 3M Company), UVE-1014 (manufactured by General Electric company), mixtures of triallylsulfonium hexafluorophosphate salts such as Uvacure 1590 and Uvacure 1591 (both manufactured by Daicel UCB), metallocene compounds such as Irg-261 (manufactured by Ciba-Geigy Corp.), diphenyliodonium hexafluoroantimonate and P-nonyl phenyl phenyl iodonium hexafluoroantimonate, 4,4′-diethoxyphenyliodonium hexafluoroantimonate and like polyaryl iodonium salts. These photopolymerization initiators may be used singly or in combination of two or more kinds.

In the above constitution, the fixture 216 is supported by the supporting member 213 at it both ends and rotated at the same time. At this time, the outer circumferential surface of the fixture 216 and the inner periphery face of the material 202′ are set so as to fit in such a degree that the material 202′ can be rotated in synchronization with the fixture 216. Otherwise, the fitting between the outer circumferential surface of the fixture 216 and the inner periphery face of the material 202′ may be loosened to rotationally drive the material 202′ directly by a rotationally drive 214.

While the material 202′ is rotated in such a manner, the ink 212 is discharged from the nozzle 211 so that the microdroplets of the ink 212 land a predetermined position of the outer circumferential surface 202a of the material 202′. A hydrodynamic groove pattern is formed with aggregates of these microdroplets on the outer circumferential surface 202a of the material 202′ as the hydrodynamic pressure producing part. In the hydrodynamic groove pattern, for example, raised demarcation portions Ha and regions not coated with the ink, i.e., hydrodynamic grooves Hb are arranged in a herringbone shape. At this time, at each nozzle 211, the supply and stop of the ink 212 is appropriately switched at the timing established in advance. The formation of this hydrodynamic groove pattern is carried out in a manner of gradually proceeding in the circumferential direction of the outer circumferential surface 202a of the material 202′ with the rotation of the fixture 216. When a printed portion proceeds to a certain degree in the circumferential direction (halfway in the example shown in the FIG.), the printed portion reaches a region opposing the curing member 215 (curing step), and the ink 212 which has received the ultraviolet irradiation causes a polymerization reaction to be sequentially cured. This curing of the ink gradually proceeds in the circumferential direction of the material 202′ with the rotation of the material 202′.

When a portion printed first makes a single full rotation and reaches a region opposing the nozzle head 217, the nozzle head 217 is slid to a region opposing the outer circumferential surface 202a of a neighboring material 202′. While the fixture 216 continues to be rotated, a new hydrodynamic groove pattern is formed on the neighboring material 202′ in a similar manner. This cycle is continued until printing of all the materials 202′ is completed. It is then confirmed if all the ink 212 has passed the region opposing the curing member 11 and is cured, and the rotation is stopped to remove the fixture 216 from the supporting member 213.

When the constitution of the present invention is not used, for example, carrying out printing only on a single material 202′ may raise the necessity of continued rotational driving (idling) until the ink 212 is completely cured, increasing the cycle time. Moreover, when it is necessary to carry out attachment to and removal from the apparatus many times or in other cases, the time that the hydrodynamic pressure producing part is not directly relate to printing (so-called, preparation time) is inefficiently extended.

In contrast, continuous printing is enabled by serially connecting a plurality of materials 202′ as in the present invention, and the formation of the hydrodynamic groove pattern can be carried out very efficiently. When printing on the single material 202′ is completed, the nozzle head 217 can be slid to start printing of a neighboring material 202′. At this time, curing of the ink in the previous material 202′ can be also carried out during printing of a next neighboring material 202′. Therefore, the printing step and curing step can be simultaneously conducted, enabling the formation efficient of the hydrodynamic groove pattern. In addition, the number of times of attachment to and removal from the printing apparatus material 202′ and the preparation time can be greatly reduced. Therefore, the cycle time can be greatly shortened and the production costs of the hydrodynamic pressure producing part can be greatly reduced.

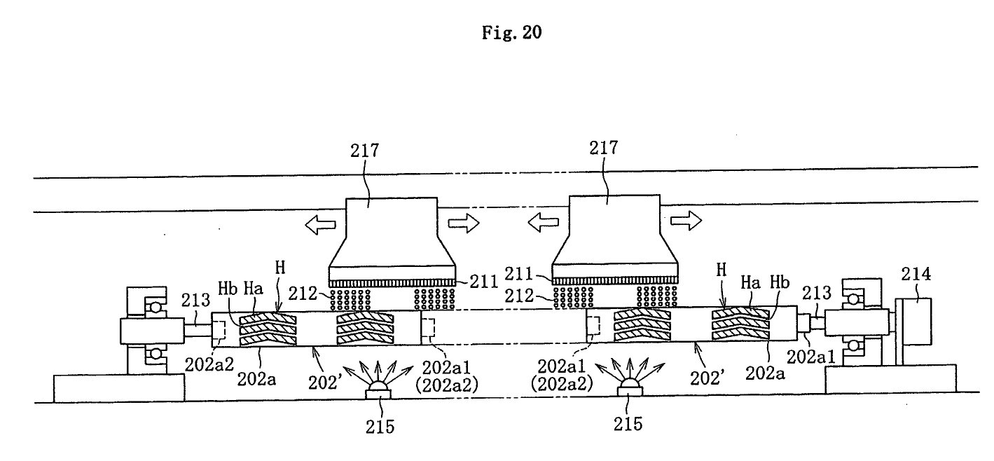

Moreover, since a plurality of materials 202′ are serially connected by a fixture 216 to ensure the coaxiality, a variation in the molding precision of each material can be prevented, while the highly accurate hydrodynamic groove pattern can be formed in all the materials 202′. It should be noted that the connection of the plurality of materials 202′ while ensuring their coaxiality, for example, as shown in FIG. 20, can be carried out by fitting it with the recess 202a2 of the neighboring material 202′ a projection 202a1 provided at the shaft end of one of the materials 202′, as well as by using the above-mentioned fixture 216.

In the example shown in the FIG., the case where two nozzle heads 217 are used is shown as an example, but this can be disposed at one position or three or more positions in the axial direction, or a plurality of positions in the circumferential direction. Further, the hydrodynamic groove pattern is printed throughout the entire circumference while the material is fully rotated once, or the material 202a′ is rotated for more times, for example, rotated for two to a few ten times, the hydrodynamic groove pattern can be formed throughout the circumference of the material 202a′. Moreover, as the curing member 215 can be used, for example, that having high diffusibility of the light (ultraviolet ray) by fixing it, that having high light-concentration ability can be used to slide it in the axial direction along with the nozzle head 217. Moreover, in the above-description, the constitution is set to start printing of a neighboring material 202′ at the point when printing of the hydrodynamic groove pattern on the individual material 202′ is completed, but printing of a plurality of materials 202′ can be simultaneously conducted by sliding of the nozzle head 217.

By the ink jet method, microdroplets of the ink 212 according to a preliminarily programmed shape pattern are precisely discharged. Therefore, a hydrodynamic groove pattern as a hydrodynamic pressure producing part can be printed highly accurately. In addition, the cured ink 212 itself can ensure a required depth (a few μm to a few ten μm) of the hydrodynamic grooves, enabling the part to be used as the shaft portion 202 with hydrodynamic grooves as it is.

Moreover, in printing by the inkjet system, there is not contacting part between the printing mold and the material 202′ as in a known screen printing machine. Reduced printing precision due to the abrasion at the contacting part when produced in quantity can be avoided. In addition, when a plurality of materials 202′ are connected in the axial direction as mentioned above, a pressure applied from a nozzle to the material 202′ does not affect, and therefore lowered printing precision due to warping of the connected material 202′ can be avoided. Further, since the printing mold, printing screen for retaining for the printing mold or the like is unnecessary and a mechanism for moving the printing mold depending on the rotation of the material 202′ is also unnecessary, the structure of the molding apparatus can be simplified. Moreover, because the ink used is required only in an amount involved in the formation of the hydrodynamic groove pattern, the amount of the ink used can be reduced compared to a known apparatus necessitating requiring a squeegee, achieving cost reduction.

Moreover, since the printing step and curing step are provided separately in the circumferential direction of the material 202′, the part printed first is cured by the ultraviolet irradiation from the curing member 215 and then returned to a position opposing the nozzle head 217. Hence, insufficiently cured ink overlaps to avoid accidental collapse of the hydrodynamic groove pattern. Furthermore, since the nozzle head 217 and the curing member 215 are disposed at the positions opposing each other across the material 202′, the ultraviolet ray irradiated from the curing member 215 is screened by the material 202′. Therefore, the curing action of the ultraviolet ray does not affect the nozzle 211, thereby preventing clogging or like problems of the nozzle 211 by the ultraviolet irradiation.

The material 202′ (fixture 216) is rotationally driven in the above description, but the material 202′ may be fixed, and the nozzle head 217 and curing member 215 may be rotationally driven about the material 202′.

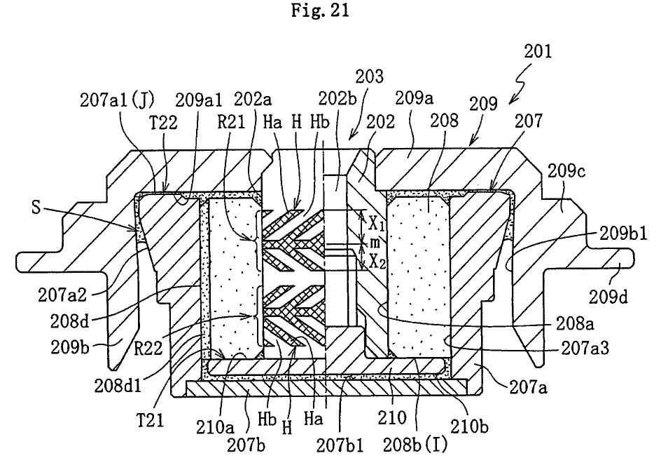

FIG. 21 shows an example of the hydrodynamic bearing apparatus in which the rotational member 203 having the shaft portion 202 manufactured by undergoing the above steps is integrated. This hydrodynamic bearing apparatus 201 comprises as main components parts a housing 207 comprising the side portion 207a and a bottom material 207b which is separate from the side portion 207a closing one end opening of the side portion 207a, a bearing sleeve 208 fixed on the inner periphery of the housing 207, and the rotational member 203 which comprises the shaft portion 202 at the rotational center and relatively rotates relative to the housing 207 and bearing sleeve 208. It should be noted that for the sake of explanation, the side of the bottom material 207b is referred to as the lower side, and the side opposite to the axial direction of the bottom material 207b is referred to as the upper side in the description provided below.

The rotational member 203 is constituted of, for example, a hub member 209 covering the top of the housing 207, and the shaft portion 202 inserted at the inner periphery of the bearing sleeve 208. The shaft portion 202 has a through hole 202b which allows its axis to pass therethrough. In this embodiment, the hub member 209 and the shaft portion 202 are formed separately and fixed by a suitable means such as press fitting, adhesion and welding.

The hub member 209 comprises a disk portion 209a disposed above the housing 207, a cylindrical portion 209b extending downward in the axial direction from the outer circumference of the disk portion 209a, a disk loading face 209c and a brim 209d provided on the outer periphery of the cylindrical portion 209b. A not shown disk-shaped information recording medium is fitted onto the outer periphery of the disk portion 209a and mounted on the disk loading face 209c. The disk-shaped information recording medium is retained on the hub member 209 by a not shown appropriate retaining means.

The shaft portion 202 separately comprises a flange portion 210 as a slip-off preventive means at its lower end. The flange portion 210 is made of a metal, and, for example, is fixed onto the shaft portion 202 by a means such as screw connection, whereby the lower end of the through hole 202b is closed. At the upper end of the through hole 202b, a clamper (not shown) which holds a disk-shaped information recording medium between the upper end of the through hole 202b and the hub member 209 is fixed, for example, by a means such as screw connection, thereby closing the upper end of the through hole 202b.

On the outer circumferential surface 202a of the shaft portion 202, a radial bearing face H including hydrodynamic grooves Hb arranged for example, in a herringbone shape as the hydrodynamic pressure producing part and a demarcation portion Ha forming and demarcating the hydrodynamic groove Hb is formed separately in the axial direction. On the upper radial bearing face H, the hydrodynamic grooves Hb are formed axially asymmetrically relative to the axial center m, and an axial dimension X1 of the region above from the axial center m is larger than the axial dimension X2 of the region below the center m. Accordingly, when the shaft portion 202 is in rotation, the drawing force of a lubricating oil (pumping force) by the hydrodynamic groove Hb becomes relatively larger in the upper radial bearing face than in the lower symmetrical radial bearing face.

The bearing sleeve 208 cylindrically formed from a porous body made of a sintered metal, especially a porous body of a sintered metal comprising copper as a main component, or from a soft metallic material such as brass and aluminum (aluminum alloy). The inner periphery face 208a of the bearing sleeve 208 is formed as a smooth and cylindrically curved surface. In a partial annular region of the lower end face 208b of the bearing sleeve 208, although not shown in the FIGS., for example, a thrust bearing face I including a plurality of hydrodynamic grooves arranged in a spiral shape and demarcation portions forming and demarcating the hydrodynamic grooves is formed. It should be noted that the shape of the hydrodynamic grooves employed may be the above-mentioned shape or others such as a herringbone shape.

Moreover, a single or a plurality of axial grooves 208d1 for bringing both ends of the bearing sleeve 208 into communication are formed in the axial direction throughout its length on the outer circumferential surface 208d of the bearing sleeve 208. In this embodiment, three axial grooves 208d1 are formed at regular intervals in the circumferential direction.

The housing 207 is constituted of an approximately cylindrical side portion 207a and a bottom material 207b which closes the opening at one end of the side portion 207a as the bottom separate from the side portion 207a. For example, the side portion 207a is formed from of resin material, and the bottom material 207b from a metallic material such as stainless steel and brass. The bottom material 207b is fixed by adhesion, press fitting or like means to the lower end of the side portion 207a.

In a partial annular region of the upper end face 207a1 of the side portion 207a, although not shown in the FIGS., a thrust bearing face J including a plurality of hydrodynamic grooves arranged, for example, in a spiral shape and a demarcation portion forming and demarcating the hydrodynamic grooves are formed. It should be noted that the shape of the hydrodynamic grooves employed may be the above-mentioned shape, a herringbone shape or other shapes.

An outer wall 207a2 which gradually expands towards the top in a tapering manner is formed on the outer periphery of the side portion 207a. This tapering outer wall 207a2 forms an annular sealing space S whose radial dimension becomes gradually smaller from the lower end side of the housing 207 towards the top between itself and the inner periphery face 209b1 of the cylindrical portion 209b. This sealing space S is in communicate with the outer diameter side of the thrust bearing gap a thrust bearing portion T22 when the shaft portion 202 and hub member 209 are in rotation.

Next, the assembly steps of the hydrodynamic bearing apparatus 201 according to this embodiment will be described.

Firstly, the bearing sleeve 208 is fixed on the inner periphery face 207a3 of the side portion 207a constituting the housing 207 by a means such as press fitting adhesion. Secondly, the shaft portion 202 formed integrally with the hub member 209 is inserted into the bearing sleeve 208 fixed on the side portion 207a. Thereafter, the flange portion 210 is placed on the shaft portion 202, for example, by screw connection, and then the bottom material 207b is fixed to the inner periphery on the lower end side of the side portion 207a by, for example, press fitting and adhesion.

When the assembly mentioned above is completed, the shaft portion 202 of the rotational member 203 is inserted at the inner periphery face 208a of the bearing sleeve 208, and the flange portion 210 is situationally contained in the space between the lower end face 208b of the bearing sleeve 208 and the upper end face 207b1 of the bottom material 207b. Thereafter, for example, a lubricating oil is poured into the inner space of the hydrodynamic bearing apparatus 201 including the inner pores inside the bearing sleeve 208, as a fluid (lubricating fluid). At this time, the oil level of the lubricating oil is maintained within the range of the sealing space S.

In the hydrodynamic bearing apparatus 201 having the above constitution, when the rotational member 203 (shaft portion 202) rotates, the radial bearing faces H separately formed by the outer circumferential surface 202a of the shaft portion 202 oppose the inner periphery face 208a of the bearing sleeve 208 across radial bearing gap. With the rotation of the shaft portion 202, the lubricating oil filling each radial bearing gap produces the hydrodynamic effect, and the shaft portion 202 is rotatably supported by the pressure in the radial direction in a non-contact manner. Accordingly, a first radial bearing portion R21 and a second radial bearing portion R22 which rotatably support the shaft portion 202 in the radial direction in a non-contact manner is formed.

Moreover, a thrust bearing gap (not shown) is formed between the lower end face 208b of the bearing sleeve 208 and the upper end face 210a of the flange portion 210. The hydrodynamic effect is produced by the lubricating oil in this thrust bearing gap, and a first thrust bearing portion T21 which rotatably supports the rotational member 203 in the thrust direction in a non-contact manner is formed. similarly, a thrust bearing gap is formed between the upper end face 207a1 of the side portion 207a of the housing 207 and the lower end face 209a1 of the hub member 209 constituting the rotational member 203. With the rotation of the rotational member 203, the hydrodynamic effect is produced in this thrust bearing gap by the lubricating oil, and a second thrust bearing portion T22 which rotatably supports the rotational member 203 by the pressure in the thrust direction in a non-contact manner is formed.

A hydrodynamic bearing apparatus having the hydrodynamic pressure producing part formed by the method of the present invention can be desirably used not only for the above-mentioned apparatus but also for hydrodynamic bearing apparatuses having other constitutions. In the description provided below with reference to the drawings, the constitution shown in FIG. 21 and identical constitutional components and elements are referred to by the identical symbols, and repeated explanation is dispensed with.

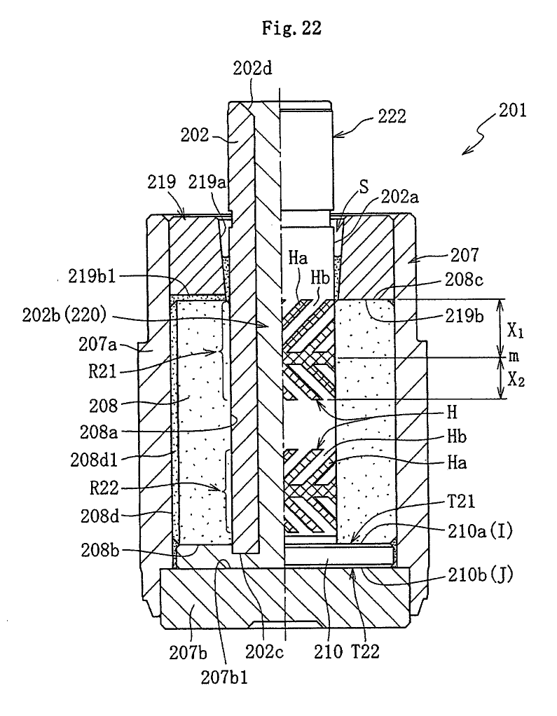

FIG. 22 shows another constitutional example of the hydrodynamic bearing apparatus 201. A major difference between this hydrodynamic bearing apparatus 201 and the hydrodynamic bearing apparatus shown in FIG. 21 is that, the shaft member 222 formed of the shaft portion 202 and flange portion 210 forms a complex structure of a metallic material and of a resin material, the second thrust bearing portion T22 is formed between the lower end face 210b of the flange portion 210 and the opposing upper end face 207b1 of the bottom material 207b, an annular sealing member 219 separated from the housing 207 is fixed to the upper end inner periphery of the side portion 207a, and that the sealing space S is formed between this inner periphery face 219a and the outer circumferential surface 202 of the opposing shaft portion 202.

The shaft portion 202 comprises the material 202′ used in FIG. 19, and the hydrodynamic pressure producing part (radial bearing face H) is formed on the outer circumferential surface 202a by the above ink jet method. The through hole 202b in the axial direction formed on the shaft portion 202 is filled throughout the length of resin material 220 in the axial direction, and integrally forms the entire flange portion 210 overhanging from the lower end of the shaft portion 202 towards the outer diameter side. Usable as the resin material 220 are thermoplastic resins such as PA66 (66 nylon), LCP (liquid crystal polymer), PPS (polyphenylene sulfide), and if necessary, fillers such as glass fibers are added to these resin materials.

In this constitutional example, to prevent detachment of the shaft portion 202 (metallic material) and the resin material 220, the metallic material and resin material 220 are in an engaged state by the lower end 202c of the shaft portion 202 embedded in the flange portion 210 and a tapered face 202d provided on the side of the upper end inner periphery of the shaft portion 202.

This shaft member 222 is made by the injection molding (insert molding) of a resin using the shaft portion 202 as an inserted part. In this type of the shaft member 222, in view of the function of the bearing apparatus, high dimensional accuracy including the perpendicularity of the shaft portion 202 and flange portion 210 and the parallelism at both end faces of the flange portion 210 are required. If insert molding is employed, said requirement precision can be ensured only by increasing the mold precision and accurately positioning the shaft portion 202 as an inserted part within the mold and at the same time mass production at low costs is enabled only by increasing the mold precision and accurately positioning the shaft portion 202 as an inserted part within the mold. Moreover, the first thrust bearing face I and second thrust bearing face J are formed in partial annular regions on both end faces 210a, 210b of the flange portion 210, respectively, simultaneously in the injection molding.

The shaft member 222 having the above constitution can greatly reduce the weight of both the shaft portion and flange portion compared to that formed from a metallic material. Therefore, the impact caused when the shaft member 222 collide with the bearing sleeve 208 or the bottom material 207b is reduced, the possibility of damages can be lowered at the collision portion. Moreover, since the flange portion 210 is made of a resin, sliding characteristics for the lower end face 208b of the bearing sleeve 208 made of a metal and the upper end face 207b1 of the bottom material 207b is improved, enabling to reduce torque.

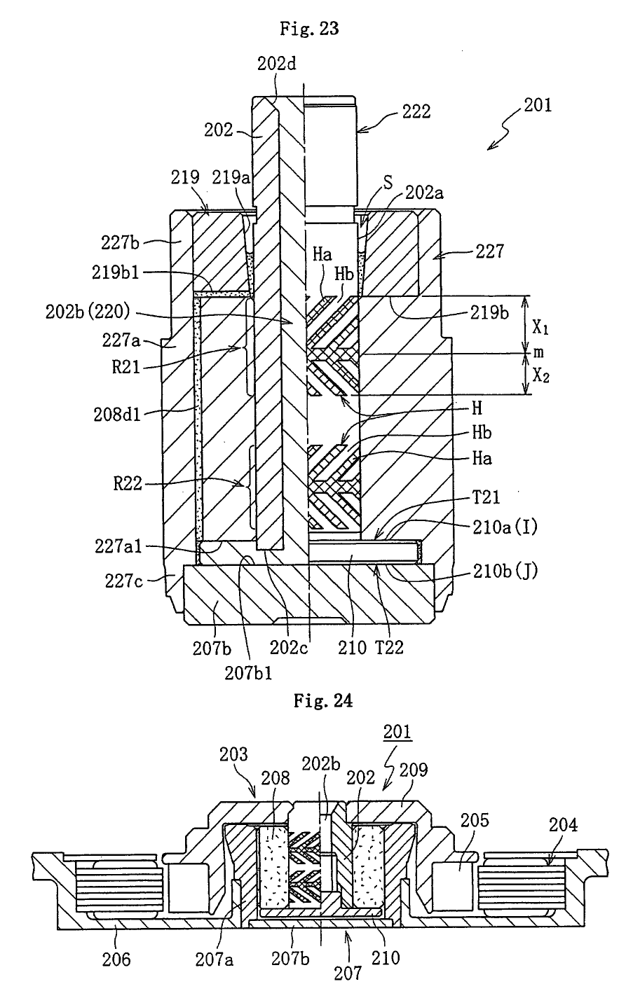

Moreover, in the hydrodynamic bearing apparatus 201 shown above, the bearing sleeve 208 and housing 207 (side portion 207a) are separately formed, but these can be integrally formed. FIG. 23 shows an example of such a constitution, where the bearing sleeve 208 and the side portion 207a of the housing 207 which are separately formed in FIG. 22 are constituted of an integral bearing component 227. In this constitutional example, the number of parts and assembly man-hour can be reduced and the hydrodynamic bearing apparatus 201 can be formed at even lower costs.

The bearing component 227 is formed in an approximately cylindrical shape from a metallic material or a resin material, and comprises the sleeve member 227a into which the shaft member 222 is inserted at its inner periphery, a seal fixing member 227b for fixing the sealing member 219 extending upwardly from the outer periphery side of the sleeve member 227a, and a bottom material fixing member 227c extending downwardly from the outer periphery side of the sleeve member 227a. Moreover, the first thrust bearing portion T21 is formed between the lower end face 227a1 of the sleeve member 227a and the opposing upper end face 210a of the flange portion 210.

Further in the constitutions shown in FIGS. 22 and 23, the sealing member 219 is formed separately from the housing 207 and bearing component 227, but these can be integrally formed so that the number of parts and assembly man-hour can be further reduced and the hydrodynamic bearing apparatus 201 can be formed at even lower costs.

In the above description, the hydrodynamic bearing apparatus using the shaft portion 202 having the through hole 202b in the axial direction shown in FIG. 19 is depicted. However, the shaft portion 202 having a projection 202a1 at one end shown in FIG. 20 and a recess 202a2 at the other end can be used to constitute the hydrodynamic bearing apparatus 201 (not shown).

By the way, the shape of the hydrodynamic pressure producing part formed on the radial bearing faces H shown above is merely an example, and hydrodynamic groove patterns corresponding to other shapes of hydrodynamic grooves (for example, spiral shape) can be formed as the hydrodynamic pressure producing part as long as it is a shape which can be printed by the ink jet method. The radial bearing faces H can be in the form of a so-called step hydrodynamic pressure producing part in which hydrodynamic grooves in the axial direction are formed at a plurality of positions in the circumferential direction, or in the form of a so-called multirobe hydrodynamic pressure producing part in which a plurality of arcuate faces in the circumferential direction are formed by a similar method.

Moreover, in the above description, the case where the radial bearing faces H are formed separately at two positions in the axial direction is shown as an example. However, the number of the radial bearing faces H is optional and the radial bearing faces H can be formed at one position or three or more positions in the axial direction.

Moreover, the hydrodynamic pressure producing part having the hydrodynamic grooves arranged in the above-mentioned spiral shape or other shapes, as well as, for example, step-shaped hydrodynamic pressure producing part and a so-called wave hydrodynamic pressure producing part (the step shape is in a wave shape) can be formed on the thrust bearing faces I, J as the hydrodynamic pressure producing part.

FIG. 24 conceptionally shows a constitutional example of a spindle motor for information appliances integrating the hydrodynamic bearing apparatus 201 shown in FIG. 21. This spindle motor for information appliances is used for disk drive units such as HDD, the hydrodynamic bearing apparatus 201 which rotatably supports the rotational member 203 comprising the shaft portion 202 in a non-contact manner, for example, stator coils 204 and rotor magnets 205 opposing each other across a gap in the radial direction, and a motor bracket (retaining member) 06. The stator coils 204 are attached to the outer periphery of the bracket 206, and the rotor magnets 205 are attached to the outer periphery of the rotational member 203. The rotational member 203 retains one or a plurality of disks D such as magnetic disks on its outer periphery. The housing 207 is fixed to the inner periphery of the motor bracket 206, for example, by a means such as press fitting adhesion. When the stator coil 204 is energized, the rotor magnets 205 between the stator coils 204 and the rotor magnets 205 are rotated by the electromagnetic force produced. Accordingly, the rotational member 203 and shaft portion 202 rotate together.

This motor has both high durability and rotational accuracy.

1. A method of molding a hydrodynamic pressure producing part, the method comprising forming a hydrodynamic pressure producing part from an aggregate of a minute amount of the ink by undergoing a printing step in which a minute amount of an ink is provided at a plurality of portions on a flat surface of a material in a non-contact manner and a curing step in which the provided ink is cured.

2. A method of molding a hydrodynamic pressure producing part according to claim 1, wherein the material is relatively slid to transport the material from the printing step to the curing step.

3. A method of molding a hydrodynamic pressure producing part according to claim 2, wherein a nozzle head comprising nozzles discharging a minute amount of the ink arranged in a plurality of rows is provided in the printing step, and the arrangement direction of the nozzles and the relative sliding direction of the material are slanted.

4. A method of molding a hydrodynamic pressure producing part according to claim 1, wherein the material is relatively rotated around its axis to transport the material from the printing step to the curing step.

5. A method of molding a hydrodynamic pressure producing part according to any one of claims 1 to 4, wherein the ink has light curability and curing of the ink is carried out by the irradiation of a light beam.

6. A method of molding a hydrodynamic pressure producing part, the method comprising a step in which a minute amount of an ink is provided on the surface of a material and a hydrodynamic pressure producing part is printed with aggregates of this minute amount of the ink, and a step in which the ink is cured,
the surface of the material being cleaned by a means selected from acid cleaning, UV cleaning and ozone cleaning prior to the printing step of the hydrodynamic pressure producing part.

7. A method of molding a hydrodynamic pressure producing part according to claim 6, wherein the acid cleaning, among the above cleaning means, is carried out by using hydrochloric acid.

8. A method of molding a hydrodynamic pressure producing part according to claim 6, wherein the acid cleaning, among the above cleaning means, is carried out under the effect of ultrasound waves.

9. A method of forming a hydrodynamic pressure producing part for producing the hydrodynamic effect in a bearing gap on the surface of a material which constitutes a shaft portion,
the method comprising providing a minute amount of an ink in the state that a plurality of the materials are connected in the axial direction, and forming a hydrodynamic pressure producing part on each material with an aggregate of a minute amount of the ink.

10. A method of forming a hydrodynamic pressure producing part according to claim 9, wherein the material is provided with a through hole in the axial direction, and each material is connected by inserting a fixture into each through hole on the plurality of the material.

11. A method of forming a hydrodynamic pressure producing part according to claim 9, wherein the material is provided with a projection at one end and a recess at the other end, and each material is connected by engaging the projection provided on one of the adjacent materials with the recess provided on the other material.

12. A method of forming a hydrodynamic pressure producing part according to any one of claims 9 to 11, where the hydrodynamic pressure producing part is formed with an ink which is caused to land or drop from a nozzle.

13. A method of forming a hydrodynamic pressure producing part according to any one of claims 9 to 11, wherein the ink is a light curable resin.
